(19) United States
(12) Patent Application Publication
(10) Pub. No.: US 2026/0208972 A1
(43) Pub. Date: Jul. 23, 2026

(54) MATERIAL HANDLING APPARATUS AND METHOD FOR SPACE EFFICIENT, HIGH SPEED TRANSPORT AND SORTATION OF ITEMS HAVING DISPARATE ITEM HANDLING CHARACTERISTICS

(71) Applicant: OPEX Corporation, Moorestown, NJ (US)

(72) Inventors: William Landi, Moorestown, NJ (US); Michael Rehrig, Moorestown, NJ (US); Alexander Stevens, Moorestown, NJ (US); Monty McVaugh, Moorestown, NJ (US); Joseph Valinsky, Moorestown, NJ (US)

(21) Appl. No.: 19/453,878

(22) Filed: Jan. 20, 2026

Related U.S. Application Data
(60) Provisional application No. 63/747,173, filed on Jan. 20, 2025.

(51) Int. Cl. B65G 47/46; B65G 43/08; B65G 47/44

(52) U.S. Cl. CPC B65G 47/46; B65G 43/08; B65G 47/44

(57) ABSTRACT

A method and apparatus are provided for automating the conveyance and transfer of items and for accommodating sortation of at least some of those items into containers to form groups, the manner in which items are transferred varying according to one or more item handling attributes (e.g., size, weight, shape, fragility, resistance to impact damage, intended destination, etc) of each item. Sortable items are transferred at an induct zone onto a first type of carrier which is dimensioned and arranged to move continuously along an elevated, looped conveyance path that overlies a plurality of movable item delivery platforms. Items are dropped onto the delivery platforms as the carriers pass overhead, the timing, direction and rate of platform movements as the items descent being determined by at least one of the item handling attributes. Each platform is configured to move along a respective vertical path sufficiently close to a corresponding group of vertically spaced destination containers that a transfer mechanism of the vehicle is operable to transfer one or more items into an adjacent destination container. In an embodiment, items too large or too heavy to be dropped or transferred into one of the containers are transferred to an alternative type of carrier and, at a discharge zone along the looped conveyance path, such items are diverted away from the looped conveyance path and onto a chute, conveyor other discharge assistant by operation of a discharge mechanism.

### FIELD OF THE INVENTION

The present invention relates to material handling systems and, more particularly, to systems and methods for aggregating inventory items into groups.

### BACKGROUND OF THE INVENTION

Various systems have been proposed for automating the aggregation of items of inventory into groups prior to their shipment to diverse destinations as, for example, to customers in the fulfillment of e-commerce orders, to retail points of sale, or to regional distribution centers. The attractiveness of such sortation systems is typically attributed to their high accuracy, labor-savings and, to a degree, their scalability. The inventors herein have observed, however, that the floor space, capital investment, and overall system complexity grow dramatically with increases in the overall daily volume of assigned sortation tasks and total number of destinations to which items must be sorted.

### SUMMARY OF THE INVENTION

The aforementioned limitations are addressed, and an advance is made in the art, by systems and methods of transporting and sorting items which are characterized by high rates of throughput, an ability to process diverse categories of items as, for example, individual items (“eaches”), containers of more than one of same item (e.g., “cases”), and containers of multiple, but different items. Systems and methods consistent with the present disclosure are also capable of transporting and, as applicable, sorting items despite differences in the manner in which such items should be handled. Item handling attributes which may vary may include, but are not limited to, differences in size, shape, weight, degree of stability (or instability), susceptibility (or resistance) to impact damage, and packaging type (cardboard, plastic, bubble-wrap, etc).

In embodiments, methods and systems are provided for automating the conveyance and transfer of items and for accommodating sortation of at least some of those items into containers to form groups. The manner in which items are transferred and, if applicable, delivered to sort destinations, varies according to one or more item handling attributes. The attributes may be determined either indirectly, by acquiring information directly from the item using a scanning, imaging or radio frequency interrogation process and using that information to retrieve the attribute(s) from a local or remote database, by direct measurement—by using one or more sensors to determine such data as the weight, dimensions, density characteristics, and/or shape of items, or by using a combination of such means.

Items to be sorted to a container of a vertical array of containers, if not excluded on the basis of one or more of the determined item handling characteristics, are transferred onto a first type of carrier. Optionally, those items which are excluded from sortation to a container of the array of containers, but for which a destination can be determined at or prior to the time the items reach an induction zone, are transferred onto an alternative type of carrier. Whether one or multiple types of carrier are employed, the carriers are configured, dimensioned, and arranged to travel continuously along a looped conveyance path.

In embodiments, the conveyance path along which the carriers move passes through or along at least a portion of an induction zone. At least a portion of the conveyance path also overlies a plurality of vertically movable, mobile delivery platforms. Each item delivery platform is movable vertically within the space defined by a corresponding column of a rack structure, the column space giving each platform the access needed to transfer items to any of a group of vertically spaced containers disposed along at least one of the front or rear faces of the columns. Collectively, the column spaces define an aisle.

An item to be sorted to a vertical column of containers, of the array of containers, is dropped by a carrier onto one of the movable delivery platforms as the carrier passes overhead. In an embodiment, the timing, direction and rate of platform movements as an item descends is determined by reference to the item handling attributes for such item. For light, non-fragile and/or impact resistant items (and/or those below a recommended weight threshold packaged to resist impact damage), the movement profile governing movement(s) of a delivery platform may maintain the platform at a stationary or, alternatively, a slow and constant rate of descent (e.g., toward the elevation at which the item is to be transferred to a destination container). On the other hand, for fragile or otherwise non-impact resistant items, for items otherwise meeting the dimensional and weight criteria for such sortation but of unverified information about resistance to impact damage or non-fragility, or otherwise deemed not so heavy or fragile to be preclude discharge onto a delivery platform but nonetheless having the potential to damage the platform, the delivery platform may be operated according to one or more movement profiles established a priori for that specific item, a category of items to which the specific item belongs, or universally for the class of items sharing one or more attributes with the specific item.

By way of illustrative example, while a light, fragile item dropped from a carrier is descending toward a movable delivery platform along a trajectory, the movement profile implemented by the delivery platform may include a first phase in which the platform accelerates at a rate substantially higher than the standard gravitational rate and a subsequent phase of deceleration up to the point where the item comes into contact with the support surface of the delivery platform. To avoid damage to a very fragile item when the former lands upon the latter, it is advantageous for the item and platform to be moving as close to the same velocity as practicable at the moment of contact. Alternatively, the difference between relative velocities may be somewhat more relaxed with items more tolerant, though not impervious, to impact damage when dropped onto a surface.

Each platform is configured to move along a respective vertical path sufficiently close to a corresponding group of vertically spaced destination containers that a transfer mechanism of the vehicle is operable to transfer one or more items into an adjacent destination container. In an embodiment, items too large or too heavy to be dropped or transferred into one of the containers are transferred to an alternative type of carrier and, at a discharge zone along the looped conveyance path, such items are diverted at a diverging or orthogonal angle away from the looped conveyance path. Diversion onto a discharge assistant such as a chute or conveyor may be achieved, for example, by properly timed actuation of an onboard discharge mechanism or of an external discharge mechanism adjacent to the discharge location. In some embodiments, carriers of the alternate type are equipped with a tilt-tray or cross-belt conveyor, the actuation of the same urging an item to be discharged in a direction orthogonal to the looped conveyance path along which the carriers are moving. Such handling may, for example, be advantageous to supply items to a bulk storage or shipment container such as a Gaylord container or the like.

In some embodiments, a determination that a container has accumulated the last of a complete group of items needed, for example, to fulfill an e-commerce order, results on the addition of container removal, transfer, and replacement tasks to the task queue(s) of an automated container extraction, re-insertion and transfer sub-system. In some embodiments, the sub-system includes a plurality of mobile container extraction and retrieval vehicles which, like the movable delivery platforms, are movable within one or more of the aisles along which the containers are arranged. In one such embodiment, the retrieval vehicles can move vertically within a subset of the column spaces comprising an aisle, movements of the retrieval vehicles being limited to the area within a column beneath the delivery platform movable within that aisle. Notwithstanding the presence of a delivery platform overhead, the rack structure defining the aisles may be advantageously dimensioned and arranged to accommodate bidirectional, lateral movement of the retrieval vehicles so that a single retrieval vehicle may service the groups of containers arranged around multiple column spaces defined by the rack structure. In other embodiments, extraction, retrieval, and reinsertion of containers is performed by one or more mechanisms operating external to the aisle(s).

According to one or more embodiments, a processor of a master controller executes instructions stored in memory for coordinating the timing of carrier discharge mechanism actuation; selecting and implementing a delivery platform movement profile based on one or more determined item handling attributes; controlling the timing, rates, and direction of downward delivery platform movement(s) needed to successfully implement the platform movement profile appropriate for the item handling attributes of the items discharged by dropping; and for coordinating further movements and transfer mechanism operations of the delivery platforms so that items are accumulated at the proper destination containers.

In an embodiment, the controller is further configured to execute instructions stored in memory for maintaining and updating queues of item and container transfer tasks and coordinating the execution of such tasks by the delivery platforms and a plurality of in-aisle mobile retrieval mechanisms in a manner which prevents collisions between the former and latter and/or between one mobile retrieval mechanism and another.

In one or more embodiments, container retrieval mechanisms are used to transfer, to carriers of the alternative type described above, respective extracted containers into which items have been deposited by operation of a single, corresponding vertically movable delivery platform. In one or more embodiments, the carriers of the item dropping type and the carriers of the alternate type which accommodate transverse transfer of containers at a discharge location, form links of an endless loop of carriers, the motion of the loop being initiated and sustained by a stationary motor disposed at a fixed location along the looped path of conveyance.

A method for transferring items to destinations according to one or more embodiments comprises: advancing a plurality of carriers along an elevated and looped conveyance path, the conveyance path encompassing an item induction zone and overlying a plurality of movable platforms wherein each movable platform is configured to move vertically along a path adjacent to a respective plurality of destination areas; at the induction zone, transferring items of the plurality of items to carriers of the plurality of advancing carriers without interrupting carrier movement; determining that a first item is to be delivered to a destination of a first group of destinations accessible to a first movable platform; dropping the first item, from a carrier of the plurality of advancing carriers, so that the first item descends along a trajectory toward a support surface of the first movable platform, wherein the first item descends at a first rate of acceleration.

The first method claims a way of transferring items to destinations using continuously moving carriers traveling along an elevated, looped conveyance path positioned above multiple vertically movable platforms. Items are inducted onto carriers without stopping carrier motion, and selected items are released from carriers so they fall under gravity toward a specific movable platform associated with a group of destinations. The method focuses on the coordinated dropping of an item toward a movable platform, with the item descending at a defined acceleration rate.

The method further includes, based on a determined characteristic of the item, accelerating the movable platform downward while the item is falling. The platform's acceleration is controlled so that its velocity substantially matches the velocity of the descending item at the point of contact, thereby reducing the likelihood of impact damage.

The method further includes controlling continued or initiated deceleration of the movable platform after the item contacts the platform, positioning the platform near a destination, and operating a transfer mechanism to move the item from the platform into a container at the destination.

The method further includes accelerating the movable platform downward at a rate greater than the rate of acceleration of the descending item until the platform velocity is substantially equal to the item velocity.

The method further includes decelerating the movable platform until the platform reaches zero velocity, bringing the platform and item to rest.

The method further includes, after deceleration, moving the movable platform vertically upward to reach a terminal position proximate a destination.

The method further includes, after deceleration, moving the movable platform vertically downward to reach a terminal position proximate a destination.

The method further includes dropping the item by actuating a discharge mechanism of a carrier as the carrier passes over the movable platform.

The method further includes actuating the discharge mechanism by engaging a latch on the carrier with a pin projecting upward from the movable platform, causing carrier elements to swing open and allow the item to drop.

The method further includes automatically returning the carrier elements to a closed and latched position after the item is released, enabling the carrier to support additional items.

The method further includes, based on a characteristic of a second item, maintaining a second movable platform in a stationary position until the dropped second item contacts the support surface of the second movable platform.

A second method claims sorting and/or transporting items using multiple types of carriers, each designed to handle items with different handling attributes. Items are inducted onto appropriate carrier types, dropped from carriers onto vertically movable delivery platforms positioned above groups of containers, and transferred from the platforms into the containers to accumulate groups of items.

The method further includes transferring items associated with a second group of handling attributes to carriers at locations outside of the main induction zone.

The method further includes operating discharge mechanisms of second-type carriers to convey or offload items along paths transverse to the main conveyance path.

The method further includes operating a retrieval vehicle to extract a container that has accumulated items and transport the container to a transfer zone for transfer to another carrier type.

The method further includes operating the retrieval vehicle to replace the extracted container with an empty container.

A material handling system claims a frame defining vertical interior passages, at least one induction zone, vertically movable platforms disposed within the passages, and carriers moving continuously along an elevated conveyance path above the platforms. The system enables items to be dropped from carriers of a first type so that the items descend along trajectories onto the movable platforms for sorting into destination groups.

The system further includes carriers of the first type having discharge mechanisms that are actuated by actuators on corresponding movable platforms to release items.

The system further includes carriers of a second type having discharge mechanisms configured to convey or offload items in a direction transverse to the elevated conveyance path.

The system further includes discharge mechanisms of the second-type carriers implemented as tilt trays or cross-belt conveyors that advance items onto chutes or transfer conveyors.

The system further includes a controller configured to control acceleration and deceleration of movable platforms so that descending items contact the platforms with matched velocities to reduce impact damage, and to advance the platforms to delivery locations.

The system further includes movable platforms each having a motor controlled by the controller and a transfer mechanism operable to move items from the platform to a destination area.

A second material handling system claims vertically arranged groups of destination areas, a controller, and movable platforms configured to accelerate downward beneath falling items, decelerate to allow the items to be supported on platform surfaces, and stop at terminal positions proximate destination areas. Each movable platform includes a transfer mechanism for transferring supported items to corresponding destination areas.

The system further includes an item carrier assembly configured to receive items, transport the items along a travel path above the movable platforms, and release the items so that the released items descend along trajectories that intersect descending movable platforms.

The system further includes a plurality of carriers in the carrier assembly, each carrier being configured to release items while moving along the carrier travel path.

The system further includes carriers having release assemblies with one or more doors movable between a support position and a release position to allow gravity-driven dropping of items.

The system further includes release assemblies having spring-driven arms and sliding latches that hold the doors in the support position until release.

The system further includes actuators on the carriers configured to initiate movement of the doors from the support position to the release position.

The system further includes doors configured to automatically return to the support position after item release by engaging ramp surfaces along the conveyance path.

The system further includes carriers having frames with first and second pivotable doors mounted on parallel hinge axes to release an item.

The system further includes carriers having a second release assembly configured to release a second item from the same carrier.

The system further includes a second release mechanism configured to release a second item along an overlapping but distinct trajectory toward a movable platform.

The system further includes separate actuators for first and second release assemblies, enabling independent release of multiple items along different trajectories.

The system further includes a controller having a processor and memory storing instructions for controlling platform acceleration, deceleration, stopping, sorter tray motion, and timing coordination.

The system further includes controller instructions for resuming movement of a stopped movable platform to reach a terminal destination position and operating a transfer mechanism to deliver an item to the destination area.

The system further includes controller instructions for operating a motor to move a stopped movable platform vertically until a terminal position is reached.

The system further includes controller logic for detecting release of an item and controlling platform acceleration and/or deceleration so that item and platform velocities are closely matched at the point of contact to reduce damage.

The system further includes controller logic for controlling platform acceleration so that the platform reaches the contact elevation at substantially the same velocity as the falling item.

The system further includes controller instructions for determining when a carrier reaches a target location and actuating the carrier release mechanism so that an item falls along a trajectory that intercepts the movable platform at the point of contact.

While the methods and apparatus are described herein by way of example for several embodiments and illustrative drawings, those skilled in the art will recognize that the inventive methods and apparatus for sorting items using a dynamically reconfigurable sorting array are not limited to the embodiments or drawings described. It should be understood that the drawings and detailed description thereto are not intended to limit embodiments to the particular form disclosed. Rather, the intention is to cover all modifications, equivalents and alternatives falling within the spirit and scope of the methods and apparatus for sorting items using one or more dynamically reconfigurable sorting array defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### BRIEF DESCRIPTION OF THE DRAWINGS

The foregoing summary and the following detailed description of the preferred embodiments of the present invention will be best understood when read in conjunction with the appended drawings, in which:

FIG. 1 is a block diagram depicting a high throughput item sortation and transport system operable under the direction of a centralized warehouse management system and forming part of, for example, an e-commerce order fulfillment arrangement, in accordance with an exemplary embodiment consistent with the present disclosure;

FIG. 2 is a block diagram depicting, in greater detail, a warehouse management system coordinating the operation of a high throughput item sortation and transport system, consistent with one or more embodiments of the present disclosure;

FIG. 3 is a block diagram depicting, in greater detail, a high throughput item sortation and transport system constructed in accordance with an exemplary embodiment of the present disclosure;

FIG. 4A is a block diagram depicting the functional components of an exemplary item induct module, which may be used to acquire one or more item handling attributes of items as they are arrive at an induction zone, prior to subsequent transport and/or sortation according to one or more embodiments consistent with the present disclosure;

FIG. 4B is a top plan view depicting components of the exemplary item induct module of FIG. 4A, according to one or more embodiments consistent with the present disclosure;

FIG. 5A is a perspective view depicting an exemplary high speed and throughput sorting array system incorporating several induction zones, which may be implemented as one or more induct stations such as the one depicted in FIGS. 4A and 4B, multiple pairs of vertically spaced sort destination containers arranged on opposing sides of a series of column space defined by a rack structure and collectively comprising an aisle, and a plurality of vertically movable delivery platforms respectively movable vertically within a corresponding one of the column space, according to one or more embodiments consistent with the present disclosure

FIGS. 5B and 5C depict an alternative implementation of an induction zone, which may be used instead of, or in addition to, induct stations such as those exemplified in FIGS. 4A and 4B, the implementation including a floor-elevation robotic induction zone 530 (FIG. 5B) which transfers items arriving at a conveyor loop to carriers at an elevated, automated transfer station by an inclined belt conveyor (FIG. 5A);

FIG. 5D is a top, partial perspective view depicting a portion of the illustrative sortation and transport system of FIG. 5A, showing an exemplary segment of the looped conveyance path along which a series of carriers move above vertically movable transfer platforms according to one or more embodiments consistent with the present disclosure;

FIG. 5E is a top, partial perspective view depicting several carriers passing along the looped conveyance path past a stationary drive motor operated to continuously move the carriers along the conveyance path and directly over the delivery platforms under that path;

FIG. 5F is a partial elevation view of the exemplary embodiment of a sortation system consistent with the configuration shown in FIG. 5A, which shows the passage of carriers over a section of the racks so as to travel above several stationary delivery platforms disposed within corresponding column spaces, the platforms being movable downwardly upon receiving an item and having a transfer mechanism operable to transfer such an item to one of the containers of a vertically spaced group of containers shown;

FIG. 6A is top perspective view showing a single carrier of a type configured to transport an inducted item supported on one or both sets of carrier doors, and to drop the item onto the surface of a target vertically movable delivery platform below it (not shown);

FIG. 6B is a perspective view showing the underside of the carrier of FIG. 6A;

FIG. 6C is a perspective view of the carrier of FIGS. 6A and 6B following release of the latching mechanism which holds respective pairs of item supporting doors together, as is necessary to initiate a drop of one or more items onto the target movable delivery platform (not shown);

FIG. 6D is top perspective view showing a single carrier of an alternate type (i.e., not configured to drop an item like the carrier configuration depicts in FIGS. 6A to 6C) configured to accommodate transport discharge of an item (e.g., a case, a container of sorted items, an oversized item, or an overweight item, or an item intended for a destination not among the arrays of sort container destinations depicted, for example, in FIG. 5A) away from the carrier in a direction transverse to the loop conveyance path;

FIG. 6E is a perspective view showing the underside of the carrier of FIG. 6D;

FIG. 7A is a perspective view of a movable delivery platform dimensioned and arranged for placement within a single column of the aisle along which first and second groups of vertically spaced containers are disposed and configured for controlled movements upwardly and downwardly within the column and with a transfer mechanism for transferring an item dropped onto the platform into one of the containers;

FIG. 7B is a side elevation view depicting orientations of platform mounted actuator mechanisms engageable and cooperable with corresponding linkages dimensioned and arranged, by upward movement of a movable delivery platform into an actuating elevation, to trigger release of the latch mechanisms which result in all doors of the carrier shown in FIG. 6A swinging into the positions shown in FIG. 6C;

FIGS. 7C and 7D depict other positions of the actuator mechanism of the movable platform of FIGS. 7A and 7B, which respectively enable actuated unlatching of a first set of carrier doors without unlatching the second set of carrier doors, and actuated unlatching a second set of carrier doors without unlatching the first set of carrier doors;

FIG. 7E depicts travel of the delivery platform depicted in FIGS. 7A to 7D into an actuating elevation which causes upwardly projecting portions of a linkage of supported by the rack structure to extend and engage the latch mechanism at points defined in the underside of the carrier (FIG. 6B) and leading to unlatching both sets of doors as shown in FIG. 6C; and

FIG. 7F depicts a pair of movable delivery platforms within adjacent column spaces;

FIG. 7G depicts a section of the track defining the endless loop path and an exemplary manner for closing the open tray doors of a carrier after they have opened and as the carrier is traveling in the direction of arrow B;

FIG. 8A is a partial front perspective view depicting the lower end of several columns of a rack structure defining column spaces dimensioned and arranged to allow not only upward and downward movement of delivery platforms within them but also, lateral movement of one or more container extraction, retrieval, transfer and re-insertion vehicles along a lower region extending between the column spaces and, upon entering a target column space, climbing movements subject only to the need to avoid interference or collision between a retrieval vehicle and the delivery platform disposed above it within a column space;

FIG. 8B is a perspective view of a container extraction/retrieval vehicle having an extraction/insertion mechanism for retrieving a container such as one of the containers depicted in FIG. 8A;

FIG. 9 is a flow diagram depicting an exemplary process for high-speed transporting and sorting of items which have disparate item handling attributes according to one or more embodiments consistent with the present disclosure;

FIG. 10 is a flow diagram depicting discrete steps of a process applicable to the transport and discharge of items at locations along the looped conveyance path traveled by one or more carrier types according to one more embodiments of a method consistent with the present disclosure; and

FIG. 11 is a flow diagram depicting discrete steps of a process which identifies or otherwise determines the item handling attributes and destinations arriving at an induct station of a plurality of such induct stations of an item induct zone, according to one more embodiments consistent with the present disclosure.

### DETAILED DESCRIPTION OF THE INVENTION

Systems and methods for transporting and sorting items disclosed herein are characterized by high rates of throughput, the ability to process diverse categories of items as, for example, (i) individual items (“eaches”), (ii) containers of more than one of same item (e.g., “cases”), and (iii) containers of multiple, but different items, and to do so in a manner which takes into account the handling limitations and/or other handling attributes of the items processes. Item handling attributes which may vary from item to item processed include, but are not limited to, differences in size, shape, weight, degree of stability (or instability), susceptibility (or resistance) to impact damage, and packaging type (cardboard, plastic, bubble-wrap, etc).

In embodiments, methods and systems are provided for determining attributes of those items, taking those attributes into consideration when selecting from among plurality of available sub-task options as part of the automated conveyance, transfer and discharge of such items to destinations, and queuing and executing various transfer and discharge sub-tasks in a manner which reduces the likelihood of damage. The attributes may be determined either indirectly, by acquiring information directly from the item using a scanning, imaging or radio frequency interrogation process and using that information to retrieve the attribute(s) from a local or remote database, by direct measurement—by using one or more sensors to determine such data as the weight, dimensions, density characteristics, and/or shape of items, or by using a combination of such means.

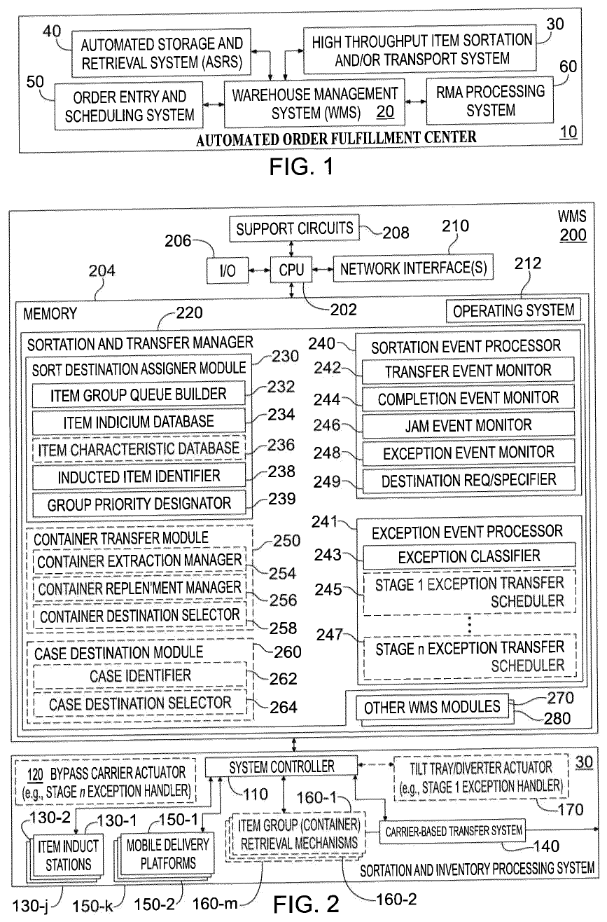

FIG. 1 is a block diagram of an exemplary automated order fulfillment center 10 which is under the direction of a centralized warehouse management system 20. The center 10 includes a high throughput item transport and sortation system 30 that is configured according to one or more embodiments consistent with the present disclosure. An alternative application of item transport and sortation system 30 is distribution centers (not shown) configured to receive, store, pick, pack, and ship goods quickly to retailers and end consumers. In both cases, center 10 acts as a central hub to move products efficiently from manufacturers to their final destination.

With continuing reference to the exemplary embodiment of FIG. 1, it will be seen that order fulfillment (or distribution) center 10 may include one or more automated storage and retrieval system(s) (ASRS as ASRS 40, an order entry and scheduling system as order entry and scheduling system 50, and a return material authorization (RMA) processing system 60.

FIG. 2 is a block diagram depicting, in illustrative detail, the integration of a high throughput, high sort destination count, item transport and sortation system 30 with a warehouse management system (WMS) 200, as may be performed in the operation of an order fulfillment or distribution center such as center 10 of FIG. 1. It will be seen that the item transport and sortation system 30 includes a system (or master) controller 110, one or more item induct stations (or item induct station modules) as item induct stations 130-1 to 130-j, a plurality of vertically movable, mobile delivery platforms indicated generally at reference numerals 150-1 to 150-k, and a carrier-based item transfer system 140.

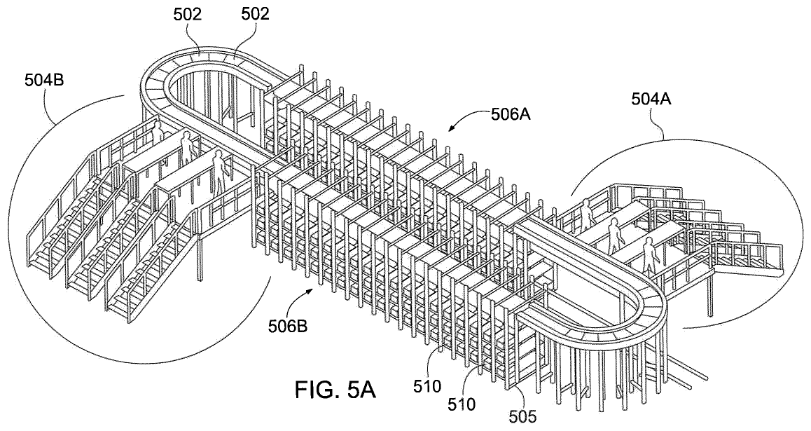

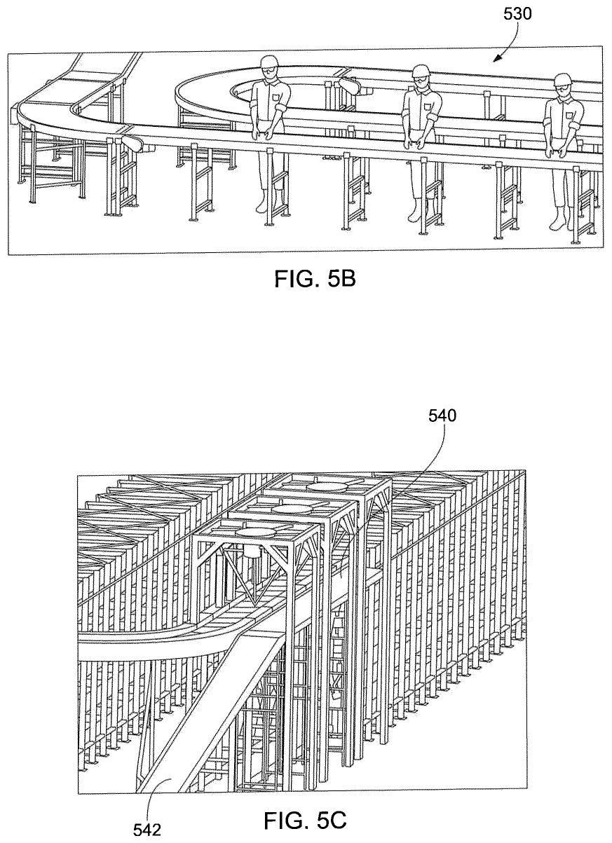

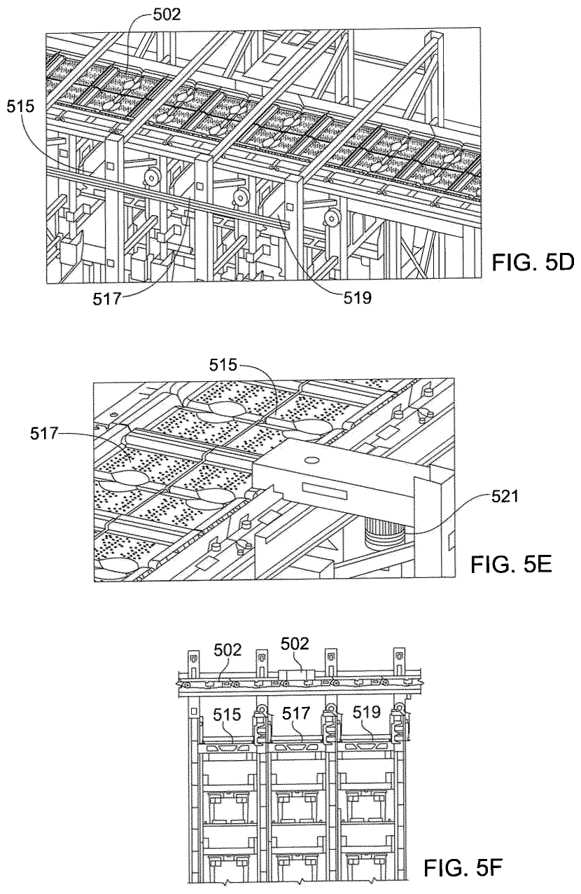

Within continued reference to FIG. 2, it will be seen that the carrier-based item transfer system 140 utilizes a series of interconnected or linked carriers or carrier modules as carriers 502 (FIG. 5A). The carriers are configured to move along a looped or “endless” conveyance path that traverses one or more induction zones as, for example zones, 504A and 504B (FIG. 5A). At least some of the carriers are equipped with a discharge mechanism and, in exemplary embodiments, the carriers are configured for continuous movement such that they pass not only through the induction zones 504A and 504B but also into positions overlying a series of vertical columns. For a purpose to be described in more detail shortly, a respective vertically movable, mobile delivery platform 150 is disposed within a corresponding one the columns.

In one or more embodiments consistent with the present disclosure, carriers of a first type are configured with an onboard item discharge mechanism which is configured to drop an item—at a selected discharge location along the looped conveyance path—onto any of the mobile delivery platforms 150-1 to 150-k. An item dropped onto a mobile delivery mechanism is, thereafter, transferred into a target container. Once a complete group of items (e.g., corresponding to an e-commerce order being fulfilled by system 10) has been transferred into a target container, the target container may be removed and replaced with an empty container. In the exemplary embodiment of FIG. 2, removal of a target container (and replacement of the removed container with an empty one) is performed in an automated fashion by one or more container retrieval and transfer mechanisms as mechanisms 160-1 to 160k.

In some embodiments, carrier modules of a second type lack the ability of the first type to drop items onto the vertically movable, mobile delivery platforms. In some embodiments consistent with the present disclosure, carrier modules of the second type include an alternative discharge mechanism. One or more carrier modules of the second type may include—as a first category of alternate discharge mechanism—an on-board tilt-tray or, alternatively, a laterally pivotable diverter that is actuatable by one or more actuators 170 offset from or adjacent to the endless carrier path (e.g., at one or more location(s) on a side of the looped path opposite a chute or outfeed conveyor. In this way, items or containers of items may be redirected by urging (and/or tilting) the items in a direction transverse to the direction of carrier movement, thereby implementing a first stage of exception handling which deviates from dropping items onto vertically movable mobile delivery platforms 150.

Alternatively, or in addition as a second form of alternative discharge mechanism, carriers of the second type may include an on-board cross belt actuated by bypass carrier actuator 120. In this case, actuation of the on-board cross-belt mechanism by bypass carrier actuator 120 redirects items in a direction orthogonal to the direction of carrier movement, thereby implementing a nth stage of exception handling.

In the embodiment depicted in FIG. 2, WMS 200 serves as a complementary controller to system controller 110 by directing or initiating the operation of certain sub-systems of system 30. To this end, WMS 200 includes a central processing unit (CPU) 202, input/output interface circuits 206, support circuits 208, and one or more network interfaces 210. CPU 202 is configured to fetch and execute instructions, stored in memory 204, to implement various sortation modules including sortation and transfer manager module 220. Manager module 220 comprises a sort designation assigner 230 for specifying the sort area destination(s) (i.e., containers) to which each item is to be delivered. In embodiments, the majority of items to be delivered to the containers are the subject of orders processed by order entry and scheduling system 50 of WMS 200 (FIG. 1). Other items that may be delivered to the containers are those which are the subject of a return material authorization (RMA) issued by processing system 60 (FIG. 1). Some items associated with an order to be processed may be too large to fit in a container along with other items of that same order or even as the only item in a container. To initiate and manage the processing of such items according to an alternate workflow, manager module 220 optionally includes an exception processor module 241. The elements and function of exception processor module 241 will be described shortly.

Sort destination assigner module 230 of sortation and transfer manager 220 further includes an item group queue builder 232 to designates a list of one or more items which will form a group destined for one or more dynamically assignable sort destination areas (e. g, containers). In some embodiments, the group queue builder 232 may assign a first subset of the items of a group to a first sort destination area or container and a second subset of the items of a group to a second sort destination area or container. Allocating the items among a plurality of sort destinations may be appropriate, for example, when the volume occupied by all of the items required for a grouping would be too large to be accommodated by a single container.

Operation of the vertically movable, mobile delivery platforms 160 is, in embodiments consistent with the present disclosure, controlled in a manner determined by such material handling attributes as, for example, item fragility, item impact resistance, and packaging robustness (e.g., the existence and effectiveness of the packing materials isolating each item in a carton from vibration, from any other items in the same carton, and from impact forces applied to the carton during shipping and handling). To this end, sort destination assigner module 230 determines at least some item handling attributes by reference to an item indicium database 234 which relates indicia and/or other acquired item data to item characteristics stored in an item characteristics database 236.

By way of illustrative example, item indicium database 234 may include a table of inducted item identifiers such, for example, as a library of UPC or QR codes, RFID tags, and/or data derived from previously acquired images of items. Such item indicia is, in the database 234, associated with the identity of items to be handled, which is used by inducted item identifier 238 to identify items. As well, the item indicia and/or item identities with which such indicia are associated, are associated with the aforementioned item handling attributes. Item characteristic database 236, in turn, is prepopulated and/or updated over time to include such item characteristics as weight, length, width and height of each item already in and/or added to inventory.

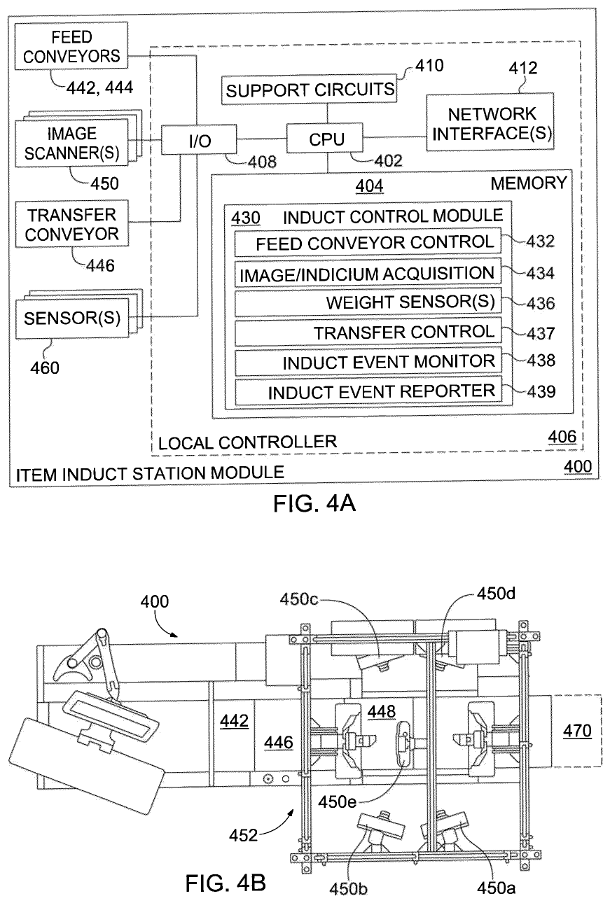

In some embodiments, the item characteristics database 236 Is constructed by accumulating data reported by an induct event monitor, as item induct event monitor 437 of the induct control module 430 depicted in the embodiment of FIG. 4A. In the embodiment of FIG. 4A, for example, item induct events are reported to induct event monitor 437, and weight data gathered by weight sensors 436 are associated with inducted items module at an induct station as station 130-1. Likewise, an appropriately positioned light plane generator, the leading and trailing edges of each item may be detected as they are carried by a feed conveyor of an induct module. As such, with knowledge of the conveyor speed, the length of the item might be detected at the induct module and reported as an event to the induct event monitor.

According to some embodiments consistent with the present disclosure, the item characteristic database 236 of sort destination assigner assigns numerical values corresponding to item handling attributes. Examples include, for at least some of the items to be sorted, a numeric, alphanumeric or some other fragility or a non-fragility value (e.g., a zero for non-fragile and a one for fragile) and/or a numeric impact resistance value (e.g., relating to an impact resistance score in terms of the range of elevations above a point of impact on surface from which an item may be dropped without sustaining unacceptable impact damage. As used herein, “unacceptable” impact damage is intended by the inventors herein to refer to that amount of damage which renders the product unmerchantable, inoperable, and/or of inferior quality or appearance relative an identical, undamaged item.

In an embodiment, a numeric value determined for an item before or as the item is dropped from a carrier onto a target mobile delivery platform 150 is compared to a threshold. If the determined value is above that threshold, the mobile delivery platform 150 may either be maintained at a constant elevation (i.e., no movement) or allowed to move vertically toward or away from the dropped item at a rate that results in a substantial difference between the velocity of the dropped item and the velocity of the mobile delivery platform at the point and time of impact.

If on the other hand, comparison of the numeric value determined for an item before or as the item is dropped from a carrier onto the target mobile delivery platform 150 reveals the value is below that threshold and therefore at meaningful risk of impact damage without controlled operation of the mobile delivery platform, the mobile delivery platform is moved according to a movement profile which determined to avoid damage to the dropped item. In embodiments, the movement profile includes one or more stages of downward movement (e.g., an initial rate that during which the mobile platform accelerates to a rate greater than the dropped item). After this first stage, the mobile platform is moved during a subsequent stage at a rate which allows the dropped item to gently contact a surface of the mobile delivery platform at a point in time when the difference in velocity between the item and mobile delivery platform is small enough to avoid unacceptable impact damage to the item. Following impact, the mobile delivery platform is decelerated and advanced to a location within a column allowing the item to be transferred into a container or other sort destination.

Alternatively, or in addition, numeric values determined for each item before or as the items are dropped from a carrier onto a corresponding target mobile delivery platform 150 are evaluated to determine whether they fall between respective ranges of values, wherein each range includes an upper threshold and lower threshold and each range corresponds to a specific acceleration and deceleration curve. For a first item for which a numeric value is determined to fall within a first range, the mobile platform may be maintained at a stationary location as described in the previous embodiment. For a second item for which a numeric value is determined to fall within a second range, the mobile delivery platform is accelerated at a first stage rate until the dropped item nearly intercepts the platform and then the delivery platform decelerates according to a first deceleration profile that results in application of an impact force having a first magnitude at the point in time when the item lands upon the delivery platform.

If the determined value for a third item is determined to be outside the second threshold and to fall within a third threshold, the mobile delivery platform is accelerated at the first stage rate and then the delivery platform decelerates according to a second deceleration profile that results in application of an impact force having a second magnitude smaller than the first magnitude at the point in time when the item lands upon the delivery platform.

In addition to sort destination assigner 230, the Sortation and Transfer control module of WMS 200 optionally includes, in some embodiments, a sortation event processor 240 which includes a transfer event monitor 242, a last item delivered/order completion event monitor 244, a jam and/or stuck discharged item event monitor 246, an exception event monitor 248, and a destination request specifier 249. Other events monitored by the sortation event processor 240 may include such events as a mobile retrieval vehicle jam or stoppage, a failure to unload an item from a movable delivery platform to a container due to the container being full or missing at the expected destination, a full destination sort area, the pre-emption of a sort destination to satisfy a higher priority order to be accumulated at the container present at that destination, and.

Cooperating with the sortation event processor is an exception event processor 241 which includes an exception classifier module 243, a stage-1 or first exception transfer scheduler 245, and one or additional or stage-n exception transfer schedulers indicated generally at 247. At least some of the exception transfer schedulers are configured to initiate actuation of discharge mechanisms of carriers of the aforementioned second type. Thus, for example, first exception transfer scheduler 245 may initiate actuation of actuator 170 in order to redirect an item to an alternate processing station, while an additional or stage-n exception transfer scheduler 247 initiates actuation of actuator 120 in order to redirect an item to a chute or conveyor for processing according to an alternate work flow.

WMS 200 may optionally implement, by execution of instructions stored in a container transfer module identified at 250, for prioritizing and/or queuing tasks for container extraction upon accumulation of a group of items needed to fulfill an order, container replenishment tasks following such extraction, determining container destinations and travel paths by reference to scheduled movements of delivery platforms 150-1 to 150-k. Container transfer module 250 includes a container extraction manager 254, a container replenishment manager 256, and a container destination selector 258.

In one or more embodiments consistent with the present disclosure, a container to which items have been sorted by operation of the carrier-based transfer system 140 and mobile delivery platforms 150, is extracted by one of a plurality of item group (container) retrieval mechanisms as mechanisms 160-1, 160-2 and 160-m. The timing and sequencing of container extraction by mechanisms 160-1 to 160-m are determined by container extraction manager 254. Container replenishment manager 256 determines the timing and sequencing for replacing any containers which have been removed with empty containers so that the sort destination re-assigned to process a new order.

In embodiments, WMS 200 may also implement, by execution of instructions stored in case destination module identified at 260, a case identification database/identifier 262, and a case destination selector 264 according to a scanned indicium, RFID interrogation, or other information acquired so that as a case is being carried by one of the carrier modules able to implement transverse discharge operations, the discharge mechanism is operated at the proper time and place along the loop conveyance path of the carrier.

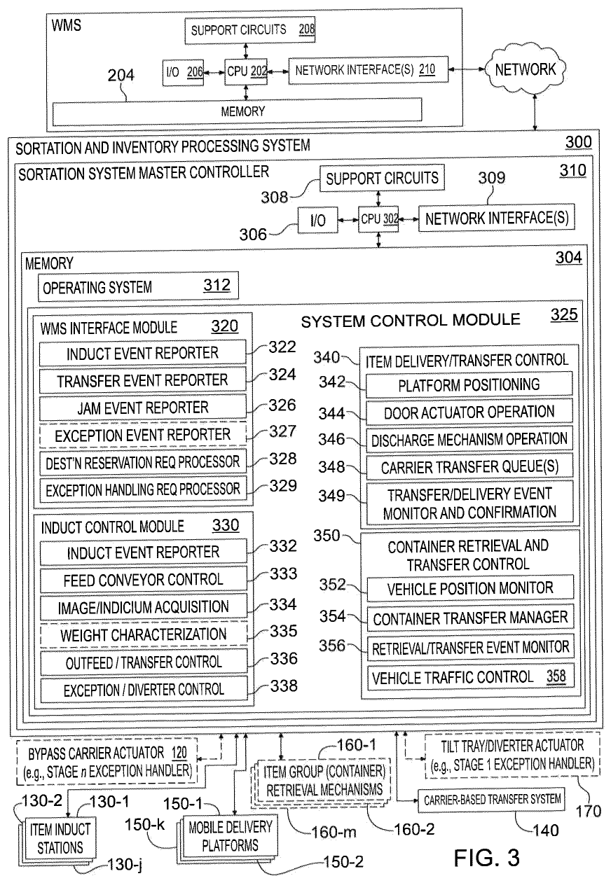

FIG. 3 is a block diagram depicting, in greater detail, a sorting system 300 constructed in accordance with an embodiment of the present disclosure consistent with the one depicted in FIG. 2, with like elements represented by like reference numerals. Sorting system 300 is configured to operate in coordination with WMS 200 and includes a master controller 310 having a central processing unit (CPU) 302, memory 304, input/output interface circuits 306, support circuits 308, and one or more network interfaces 309. CPU 302 is configured to fetch and execute instructions, stored in memory, to implement a system control module 325. Memory 304 also contains operating system 320.

According to the illustrative embodiment of FIG. 3, control module 325 comprises a WMS interface module 320, an induct control module 330, an item delivery/transfer control module 340, and a container retrieval and transfer control module 350.

WMS interface module 320 facilitates coordination of sort destination assignment, relay of event notifications, and implementation of any alert or annunciation requests initiated by the WMS 200. To this end, the WMS interface module 320 includes an induct event reporter 322, a transfer event reporter 324, a jam even reporter 326, an exception event reporter 327, a destination reservation request processor 328, and an exception handling request processor 329.

With continuing reference to FIG. 3, it will be seen that system 300 further includes an induct control module 330, an item delivery/transfer control module 340, and a container retrieval and transfer control module 350.

Induct control module 330 includes a feed conveyor control module 333, an image/indicium acquisition module 334, weight characterization sensors 335, an outfeed/transfer control module 336, and an exception/diverter control module 338. In some embodiments, each of induct module(s) as 130-1 to 130-j include one or more feed conveyors and a robotic transfer arm for picking up and depositing items onto the moving carrier modules as they pass through the induction zone(s). In alternate embodiments, human operators stationed at an induct station/module perform the transfer.

In some embodiments, each vertically movable delivery platform is movable along a linear path upward and downward within the corresponding column space defined by the rack structure extending between columns of vertically spaced containers. Each platform includes, in one or more embodiments an onboard item transfer mechanism such as an item supporting belt which can be advanced in at least one direction to transfer the item dropped from an overhead carrier module into a sort destination area. Item delivery/transfer control module 340, in exemplary embodiments consistent with the present disclosure, includes an instruction generator module 342, for formulating platform positioning and accelerating/decelerating instructions to be transmitted (e.g., over a wireless data transmission path) according to one of a plurality of item handling movement profiles related in a database to one or more item handling attributes applicable to each item being dropped. As well, delivery/transfer control module of master controller includes a door actuation operation module 344, delivery platform transfer mechanism operation module 346, carrier transfer tasks queue(s) 348, and a discharge/transfer event monitor and confirmation module 349.

As shown in FIG. 3, the system controller of an exemplary embodiment of system 300 further includes a container retrieval, replenishment, and transfer control module 350 having modules associated with the coordination of container movements and the operation of the retrieval mechanism to perform sub-tasks associated with the operation of an automated mechanism for extracting, relocating, transferring, and replacing of the containers as they are removed for shipment or discharge into a shipping container at another destination. In an embodiment, control module 350 includes a retrieval vehicle position monitor 352, a container transfer task queue and schedule manager 354, a retrieval/transfer event monitor 356, and a vehicle/delivery platform traffic control module 358.

FIG. 4A is a block diagram depicting the functional components of an exemplary item induct module 400, which may form part of the dynamically configurable sorting array system 300 of FIG. 3, according to one or more embodiments consistent with the present disclosure. The arrangement of FIG. 4A contemplates the use of local controllers for performing at least some induct module, aisle, and alert/annunciating control functions. As such, and as seen in FIG. 4A, induct module 400 includes a local controller 406, a CPU 402, a memory 404, I/O interface circuits 408, support circuits 410, and network interfaces 412.

Referring now to FIG. 4A together with FIG. 4B, which is a top plan view depicting components of the exemplary item induct module 400 of FIG. 4A, it will be seen that induct module 400 includes three conveyor stages. A first feed conveyor stage 442, a second conveyor stage 444, and a transfer conveyor 446. An item dropped onto the item carrying surface of conveyor stage 442 is advanced in the direction of the arrow D toward the scanning zone defined by the portion of transfer conveyor 448 passing through “tunnel frame” 452. The tunnel frame 452 supports a network of image and/or line scanners 450 (FIG. 4A). In the embodiment of FIG. 4B, an exemplary network of image acquisition scanners 450 includes first and second lateral pairs of scanners indicated at 450A, 450B and 450C, 450D, respectively. The imaging fields of the image acquisition scanners 450A-450D converge at the scanning zone. Also included is a downwardly directed scanner 450E supported by tunnel frame 452 above the scanning zone.

It has been observed by the inventors herein that at commercially acceptable feed rates, it is desirable to maintain adequate spacing (typically 0.25 inches or about 64 mm) between items as they are fed into the scanning zone of the induct module 400. Such spacing ensures that the items can be singulated before being transferred onto one of the carrier modules.

FIG. 5A is a perspective view depicting an exemplary high speed and throughput sorting and transport system 500 incorporating discharging carriers 502 which are movable along an elevated, looped (endless) conveyance path which traverses several induction zones as zones 504A and 504B. The induction zones may be implemented as one or more induct stations such as the one depicted in FIGS. 4A and 4B. A group of vertically spaced sort destination or target containers 510 are arranged on opposing sides within each column space 505, the column spaces 505 being arranged in rows and columns and collectively defined by first rack structure 506A and second rack structure 506B, respectively. Collectively, the columns comprise an aisle, and each of a plurality of vertically movable delivery platforms—as platforms 150-1 to 150-k of FIGS. 2 and 3—are respectively movable vertically within a corresponding one of the column spaces 505 (FIG. 5A), according to one or more embodiments consistent with the present disclosure.

Each delivery platform is configured to move vertically so as to receive an item dropped from one of the carriers 502, reach an elevation providing access to a target container 510 and, by operation of an on-board transfer mechanism of the delivery platform, transfer the item into the target container. Repetition of these sortation sub-tasks eventually results on accumulation of a complete group of items that, for example, enables the fulfillment of an e-commerce order by subsequent emptying of the container into a carton or box, or if the container itself is a carton or box, extraction, retrieval and transfer of the container to a downstream location.

In some embodiments, at least some of the containers are re-usable bins having a bomb-bay door configuration suitable for subsequent transfer of their contents to a target shipping container by sequential operation of a retrieval mechanism that extracts the container, transports it to a transfer zone, extends the container over an open shipping carton or box, and unlatches the bomb-bay doors to unload the items. As noted above, in other embodiments, the containers themselves may be shipping cartons or boxes and these may be retrieved and transported by a retrieval mechanism suited to such a task.

FIGS. 5B and 5C depict an alternative implementation of an induction zone, which may be used instead of, or in addition to, induct stations such as those exemplified in FIGS. 4A and 4B, the implementation including a floor-elevation robotic induction zone (FIG. 5B) which transfers items arriving at a conveyor loop to carriers at an elevated, automated transfer station 540 by an inclined belt conveyor 542 (FIG. 5A).

FIG. 5D is a top, partial perspective view depicting a portion of the illustrative sortation and transport system 500 of FIG. 5A, showing an exemplary segment of the looped conveyance path along which a series of carriers 502 move above vertically movable mobile transfer platforms, as platforms 515, 517, and 519, according to one or more embodiments consistent with the present disclosure.

FIG. 5E is a top, partial perspective view depicting several carriers, as carriers 517 and 519 as they advance along the looped conveyance path past a stationary drive motor 521 operated to continuously move the carriers along the elevated, looped conveyance path and directly over the delivery platforms under that path. FIG. 5F is a partial elevation view of the exemplary embodiment of a sortation system consistent with the configuration shown in FIG. 5A, which shows the passage of carriers 502 over a section of the racks so as to travel above several temporarily stationary, vertically movable, mobile delivery platforms as mobile delivery platforms 515, 517 and 519 disposed within corresponding column spaces 505 (FIG. 5A), the platforms being movable downwardly upon receiving an item and having a transfer mechanism operable to transfer such an item to one of the containers of a vertically spaced group of containers shown.

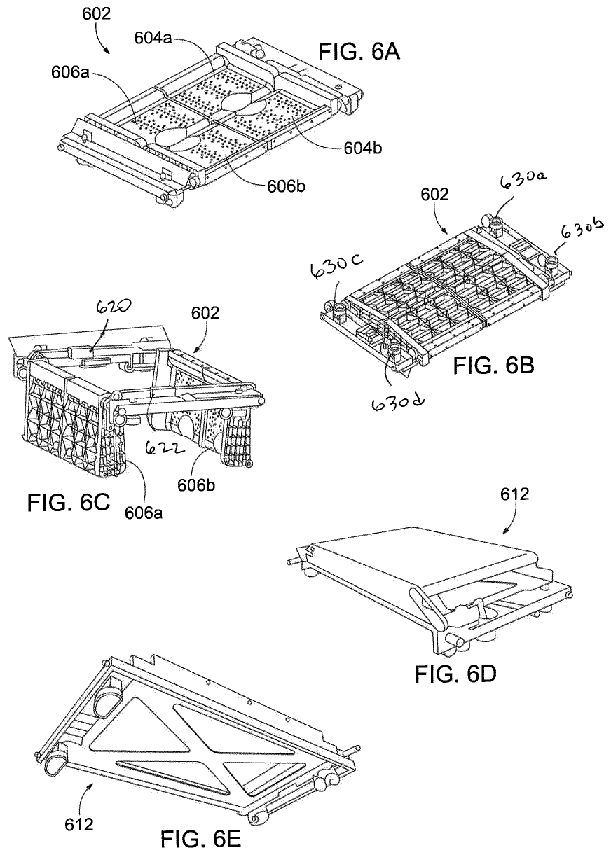

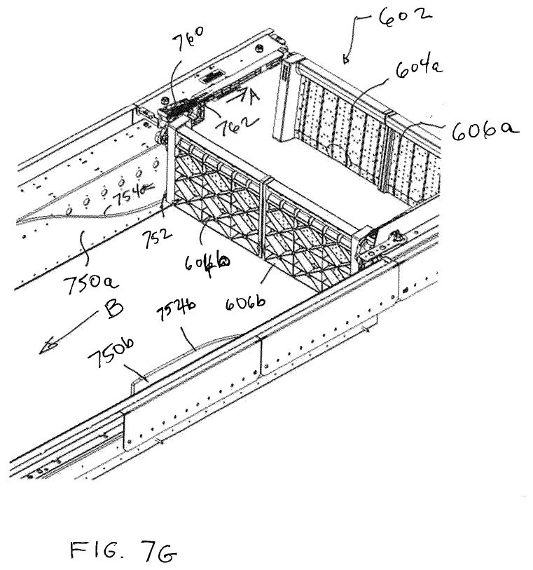

FIG. 6A is top perspective view showing a single split-tray carrier 602 of a type configured to transport one or more inducted items, with the carrier having two sets of doors, while FIG. 6B is a perspective view showing the underside of split tray carrier 602. Doors 604a and 604b form a first set of doors, while doors 606a and 606b form a second set of doors. Typically, and as shown in FIGS. 6A and 6C, door 604a and door 606a are locked together, while door 604b and 606b are also locked together. When locked together in the manner shown in FIG. 6C, both sets of doors may be actuated to open at the same time. Such operation permits a single larger item, or multiple smaller objects to be deposited on a mobile delivery platform.

With particular reference to FIG. 6C, it will be seen that a first pin-actuated latching mechanism 620 maintains the first doors 604a and 606a in the item supporting (i.e., coplanar) orientation depicted in FIG. 6A, while a second pin-actuated latching mechanism 622 maintains a second set of doors 604b and 606b in the item supporting orientation of FIG. 6A. In an alternate embodiment, a releasable locking mechanism (not shown) may be used to allow each set of doors to be operated independently of the other set doors.

It is contemplated that in some instances, synchronized release of both (or all) discharge mechanisms of the carrier will be desirable when a single item is too large to be supported and discharged by less than all discharge mechanisms. The orientation of both discharge mechanisms simultaneously actuated is depicted in FIG. 6C. However, independent actuation of a releasable locking mechanism does permit carrier 602 to discharge a first item onto a delivery platform movable within a first column space of the rack structure. The first item is then transferred into a container along that first column space, while carrier 602 may thereafter discharge a second item onto the delivery platform movable within a second column space of the rack structure downstream from the first column space along the looped conveyance path.

FIG. 6D is top perspective view showing a single carrier 612 of an alternate type (i.e., not configured to drop an item like the carrier configuration depicts in FIGS. 6A to 6C) configured to accommodate transport discharge of an item (e.g., a case, a container of sorted items, an oversized item, or an overweight item, or an item intended for a destination not among the arrays of sort container destinations depicted, for example, in FIG. 5A) away from the carrier in a direction transverse to the loop conveyance path, while FIG. 6E is a perspective view showing the underside of the carrier of FIG. 6D. In the embodiment of FIG. 6D, the carrier 612 includes an onboard discharge mechanism in the form of a tilt tray which, at one or more points along the endless looped path along which carriers 602 and 612 travel, are actuated by actuator 170 (FIG. 2 or 3) which is mounted along the looped path and engageable with the tilt tray mechanism so as to tilt a container, carton or case being carried by an upper surface of carrier 612.

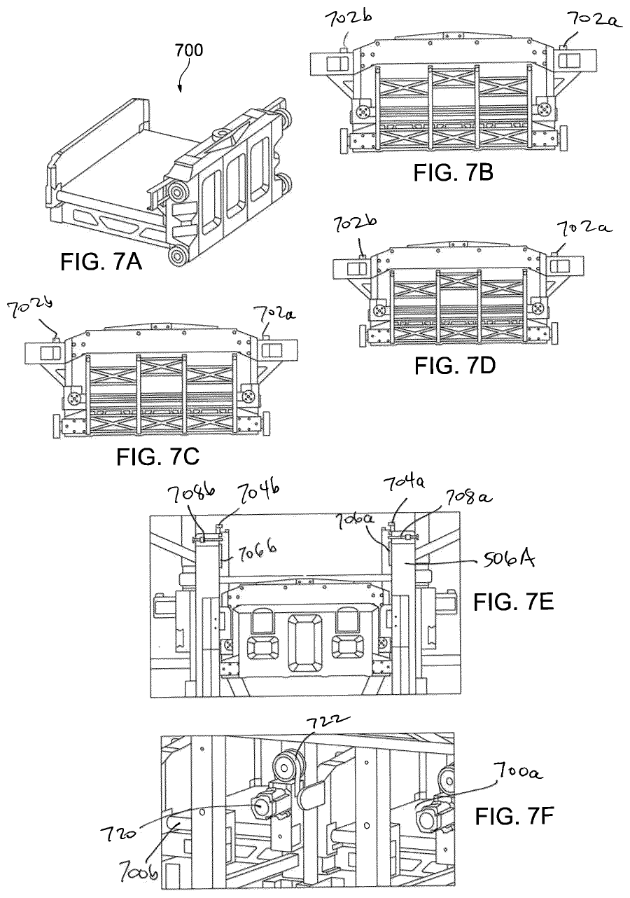

FIG. 7A is a perspective view of a movable delivery platform 700 dimensioned and arranged for placement within a single column of the aisle along which first and second groups of vertically spaced containers are disposed and configured for controlled movements upwardly and downwardly within the column and with a transfer mechanism for transferring an item dropped onto the platform into one of the containers. FIG. 7B is a side elevation view depicting orientations of platform mounted actuators 702a and 702b which are mounted to be engageable and cooperable with corresponding linkages mounted on columns of the rack structure as rack structure 506a. As will be described below in connection with FIG. 7E, upward displacement of movable delivery platform 720 into an actuating elevation trigger release of the carrier-door latch mechanisms which result in all doors of the carrier shown in FIG. 6A swinging into the positions shown in FIG. 6C.

FIGS. 7C and 7D depict other positions of the actuator mechanism of the movable platform of FIGS. 7A and 7B, which respectively enable actuated unlatching of a first set of carrier doors without unlatching the second set of carrier doors, and actuated unlatching a second set of carrier doors without unlatching the first set of carrier doors. As seen in FIGS. 7E and 7F, a pair of linearly displaceable pins 706a and 706b are spring biased in the downward direction away from the carriers passing overhead. When delivery platform 700 reaches an uppermost elevation within a column of the rack structure 506A, displaceable platform actuator pins 702a and 702b engage corresponding lower surfaces of displaceable pins 706a and 706b. Each of pins 706a and 706b are supported by bearing surfaces of support mounts 708a and 708b so that they may freely rise as the delivery platform 700 moves upwardly. Once pins 706a and 706b reach a cam surface 630a to 630d of releasable latch mechanism 620 or 622 on the underside of carrier 602, both sets of carrier doors are unlatched into the positions shown in FIG. 6C. FIG. 7F depicts a pair of movable delivery platforms 700a and 700b which are vertically displaceable within adjacent parallel column spaces. In the illustrative embodiment, movement of the platforms is driven by a motor mounted in each column of the rack structure 506a, the motor driving a respective belt coupled to a corresponding delivery platform as platform 700a

With reference now to FIG. 7G and to FIGS. 6A to 6C, there is shown in the former a section of the track which defines the endless loop path along which carriers as carrier 602 travel, as well as the exemplary manner for closing the open tray doors 604a, 606a, 604b, 604b of carrier 602 after they have been opened by actuation of mechanism 762 and as the carrier is traveling in the direction of arrow B. As seen in FIG. 7G, to each of leading doors 604b and 606 is coupled a follower only one of which, indicated generally at 752 is shown. As the carrier 602 advances, the follower 752 engages the cam surface 754a of ramp 750a. A second ramp 750b defines a cam surface 754b for follower (not shown) likewise mounted at the lateral side of door 606b. As the followers travel along surfaces 754a and 754b, overcoming the spring bias exerted by spring 760 and thereby resetting the latching mechanism 762 to the original locked position and returning the doors of the carrier 602 to their original coplanar orientation show in in FIGS. 6A and 6B.

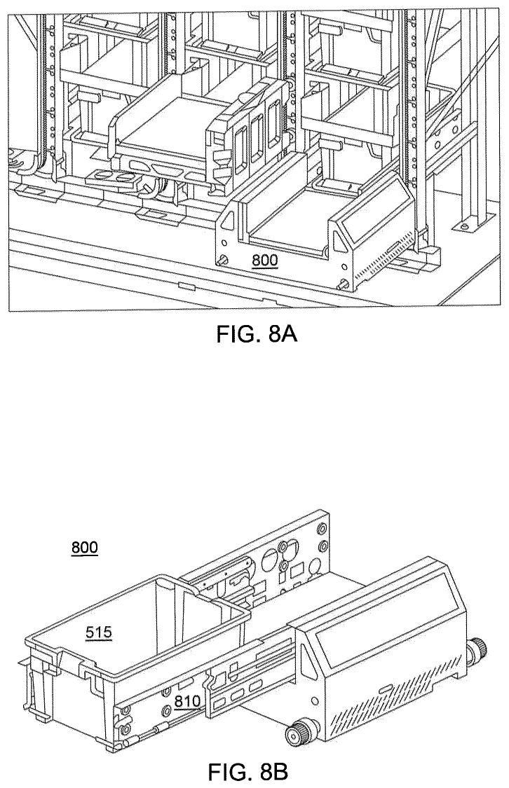

Turning now to FIG. 8A, there is shown a partial front perspective view depicting the lower end of several columns of a rack structure defining column spaces 505 (FIG. 5A) dimensioned and arranged to allow not only upward and downward movement of delivery platforms 700 within them but also, lateral movement of one or more container extraction, retrieval, transfer and re-insertion vehicles 800 along a lower region extending between the column spaces and, upon entering a target column space, climbing movements subject only to the need to avoid interference or collision between a retrieval vehicle and the delivery platform disposed above it within a column space. FIG. 8B is a perspective view of a container extraction/retrieval vehicle having an extraction/insertion mechanism 810 for retrieving a container such as one of the containers depicted in FIG. 8A.

### Operation

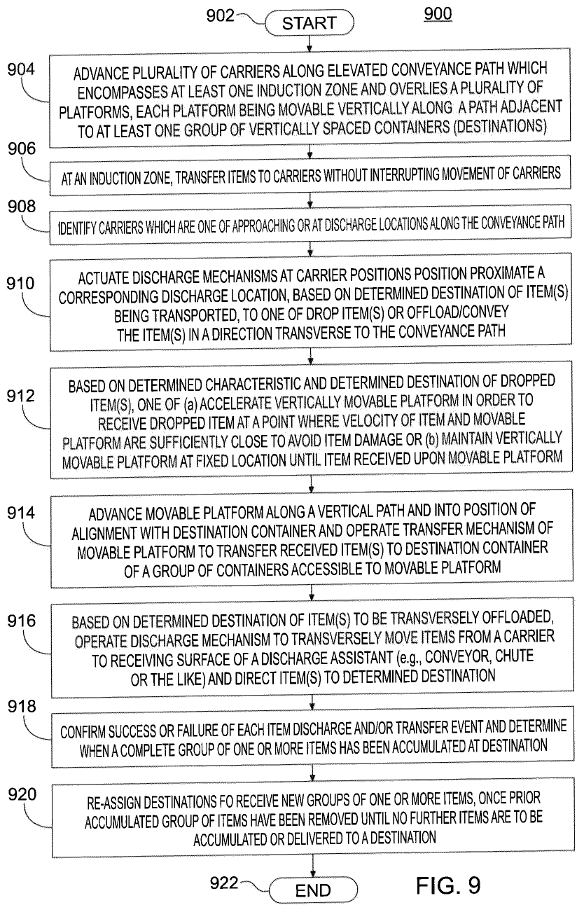

FIG. 9 is a flow diagram depicting an exemplary process 900 for high-speed transporting and sorting of items which have disparate item handling attributes. In an embodiment, method 900 utilizes multiple types of continuously moving carriers which are configured to receive items at one or more induction zones, to transport them along a looped, elevated conveyance path, and to discharge them at selectable locations along the conveyance path.

In embodiments, method 900 includes receiving a first subset of the items characterized by one or more item handling attributes which qualify them as eligible to be dropped—without damaging them—from a carrier of a first type onto the target support surface of a movable delivery platform of a plurality of independently movable platforms. In one or more embodiments, a transfer mechanism of each movable delivery platform is configured to transfer one or more items so dropped into a container as a sub-task of a sortation process which, by repetition, leads to the accumulation of respective groups of items at sort destination of the plurality of a group of sort destinations to which a movable platform has access.

In an embodiment, method 900 includes controlling operation of one or more of the independently movable platforms according to the item handling attribute of the item(s) being dropped onto them. By way of illustrative example, items characterized by light weight and/or high resistance to impact damage may be dropped onto a stationary movable platform and thereafter moved, the movable platform is downwardly or upwardly moved to a position from which the item(s) can be transferred to a target container. Conversely, when receiving fragile items not otherwise disqualified from the item handling abilities of a movable platform, method 900 may include operating the movable platform so that the item-receiving surface of the movable platform is contacted by the descending item(s) at a point in time where the difference between the velocity of the item(s) and the velocity of platform surface is small enough to avoid damage to the fragile item(s).

In embodiments, method 900 includes at least a phase of downward movable platform movement during which the movable platform accelerates a higher rate of acceleration than the 9.8 meters per sec 2 rate at which a dropped item would accelerate due to gravity (e.g. 2× the gravitational rate). A subsequent deceleration phase prior to landing of the item on the movable platform may also be included to achieve the aforementioned substantial matching of velocities between descending item(s) and platform surface. It suffices to say that the timing of acceleration and optional deceleration admits of substantial variation and are influenced by such considerations as available vertical space (e.g., faster acceleration of the movable platform will decrease the space needed for intercepting the dropped item(s) amount of time but potentially increase the space needed to slow the vehicle down after it lands on the platform. Moreover, method 900 may control the acceleration and/or deceleration phases of movable platform movement differently for different item categories or classifications, whether by configuring the movable platforms differently from one another or by varying the manner in which they are moved on an item-by-item basis.

Optionally, a second subset of the items to be processed by method 900 may have a different destination than the containers serviced by the movable platforms and/or they may have item handling attributes which render them unsuitable for dropping onto and/or for transfer by the movable platforms. One or more embodiments of method 900 accommodate the transport and discharge of such items by transferring them to carriers of a second type, wherein they are not dropped by rather they are offloaded—in a direction transverse to the looped conveyance path of the carriers—by a discharge mechanism such, for example, an on-board cross belt conveyor or tilt tray configured to advance items toward their destination(s) by moving them onto the receiving surface(s) of one or more chutes or conveyors. Alternatively, method 900 may actuate a mechanism—external to the carriers but disposed along the looped carrier conveyance path—to push items across a carrier surface and onto the receiving surface of a discharge assistant surface as the carrier passes by.

Returning to FIG. 9, it will be seen that process 900 is entered at 902, and proceeds to 904 where a plurality of carriers are advanced along a looped and elevated conveyance path which encompasses at least one induction zone for receiving items and overlies a plurality of vertically movable platforms each configured to receive and deliver items to one or more respective groups of containers, the containers being dimensioned and arranged to receive and accumulate groups of one or more items. To this end, containers of each group of containers are arranged in a column such that the containers are vertically spaced from one another and along the path traveled by one of the movable platforms. The method 900 proceeds to 906 where the method transfers one or more items to each of the carriers without interrupting the movement of the carriers along (or through) the induction zone(s).

In embodiments where method 900 processes items having disparate item handling attributes with selective diversion of items to destinations other than the containers accessible to the movable platforms, information about the items is acquired and method 900 utilizes the acquired information about the items to determine the carrier type to which the items are to be transferred, such a process being described in greater detail shortly by reference to FIG. 12. In one or more embodiments, method 900 utilizes an acquired identity of at least some of the items to associate the carrier to which one or more item(s) has/have been (or is/are scheduled to be) transferred so that the discharge mechanism of such carrier is operated at the appropriate location along the looped, conveyance path to ensure the item(s) reach(es) the intended destination. Accordingly, method 900 proceeds to 908 where method 900 identifies carriers which are approaching or are at their corresponding discharge locations along the conveyance path and, at the applicable discharge location and time, method 900 proceeds to 910 and actuates the discharge mechanism of the carriers based on the determined destination of the item(s). Depending on the carrier type and its discharge mechanism, 910 is performed by either dropping one or more items onto one of the movable platforms for subsequent transfer to a container or offloading/conveying the one or more item(s) in a direction transverse to the conveyance path along which the corresponding container is moving to accommodate subsequent transfer to a destination other than the containers). The latter operation may be advantageously applied to the transport of pre-packaged cases and/or items already sorted into a container. In one or more embodiments, such containers may be temporarily directed to the induct zone to permit heavier inducted items to be pre-placed into a container and transferred to one of the destinations serviced by a movable platform so that the addition of additional items amenable to dropping onto the platform can be accommodated.

In any event, and with continued reference to FIG. 9, it will be seen that from 910, method 900 proceeds to 912 where the determined destination is a container accessible to one of the movable platforms. At 912, method 900 discharges the item(s) from a carrier by dropping and, based on one or more item handling attributes (determined characteristics) of the dropped item(s), either (a) accelerates the movable platform downward to enable an upper surface of the movable platform to receive the dropped item(s) at a location and point in time where the velocity of the dropping item(s) and the velocity of the movable platform are sufficiently close in magnitude to avoid damage to the item(s) or (b) maintains the movable platform stationary at a location. The choice of (a) or (b), as has been described, is determined by such variables as an item's resistance (or vulnerability) to impact damage, its weight and stability and, in some cases, the manner in which it is packaged. Light, non-fragile items are especially well-suited to handling according to (b), and the inventors herein envision that significantly less cycle time and energy consumption will be achieved if the use of movement profiles requiring acceleration of the movable platforms as a sortation sub task can be reserved for those items which require it to avoid item damage.

With continuing reference to the exemplary method 900 depicted in FIG. 9, it will be seen that from 912, method 900 proceeds to 914. At 914, method 900 advances each movable platform onto which one or more item(s) have been received along a vertical path (either upwardly or downwardly) until it reaches a terminal position (i.e. a location adjacent to the destination container into which the item(s) is/are to be transferred). Method 900 then operates the transfer mechanism of each movable platform so advanced and transfers the item(s) being carried to the destination container.

From 914, method 900 proceeds to 916 where instances of the determined destination not being one of the containers accessible to the movable platforms but, rather, an alternate destination. In an embodiment, such instances are addressed at 916 by transversely offloading one or more items from the carriers upon which they are being transported. Method 900 performs the offloading at one or more discharge location disposed along the looped conveyance path and downstream of the induct zone(s) at which items were transferred to the carriers. Method 916 therefore operates a discharge mechanism so that the item is transversely offloaded/conveyed, relative to the path of conveyance followed by the carried, onto a discharge assistant such as a chute or a takeaway conveyor.

In some embodiments, carriers configured to transversely offload items are equipped with an onboard discharge mechanism such, for example, as a cross-belt conveyor or a tile tray, and method 900 actuates the discharge mechanism when the carrier is at one or more discharge locations. In other embodiments, the discharge mechanism(s) may be independent of the carriers but positioned alongside the looped path followed by the carriers, the timing of the discharge mechanism actuation being controlled by method 900 such that one or more items are pushed from a carrier surface as the carrier is transiting a corresponding discharge/transfer zone (or location) served by the discharge mechanism. Thus, without regard to the specific manner in which the discharge mechanisms are implemented, items may be readily directed by the discharge assistant to the determined destination.

Method 900 may, in embodiments, proceed from 914 or 916 to 918 employ sensors to confirm events such, for example, as discharge of an item from a carrier, or the arrival of each item at its intended destination, or any point therebetween. In an embodiment, method 900 utilizes the reporting of such events to determine that an item delivered to a container by one of the movable platforms results in the accumulation of a complete group of items needed to fulfill an order or fully satisfy some other sortation task. In one or more embodiments, method 900 responds to such a determination by, for example, scheduling automated removal and replacement of the applicable container by a mobile extraction mechanism or by generating an alert which prompts the manual removal, emptying, and replacement of the applicable container.

In the former regard, a variety of automated container extraction techniques may be employed as, for example, operating a mobile vehicle equipped with an onboard extraction mechanism to move vertically between columns of containers while the corresponding movable platform is in a non-interfering location (e.g., at or near the upper zone of its path of travel). An example of a vehicle having such an onboard extraction mechanism is described in U.S. patent application Ser. No. 18/582400 filed on Feb. 20, 2024, by OPEX Corporation, applicant for the present application.

While the presence of the movable platforms might restrict the ability of a mobile extraction vehicle to move in a complete vertical loop, provisions might otherwise be made for such vehicles to service multiple groups of containers by moving along an area beneath the movable platforms reserved for passage of mobile extraction vehicles. By way of further illustration, the containers may be automatically extracted by an extraction mechanism which operates external to the areas within which the movable platforms move. One such example is disclosed in U.S. patent application Ser. No. 17/679,079 likewise filed on Feb. 23, 2024, by OPEX Corporation. In still other embodiments, at least some of the containers—into which items have transferred by operation of the discharge platform of a movable platform—may be cartons or bags which, once removed, may be sealed for shipment and placed manually or by an articulating gripping mechanism onto a conveyor or other mechanism configured to move a stream of items to a truck loading area or cross-dock zone of a warehouse.

It should also be emphasized that notwithstanding the foregoing discussion of examples in which items having a particular item handling attribute are sorted to discrete containers by operation of the movable platforms, such examples are intended to be non-limiting. For example, in one or more embodiments, the discharge path taken by some items, notwithstanding their eligibility for sortation to containers by the movable platforms, may be transferred at an induct zone to carriers of an alternate (e.g., transversely offloading) type. Such transfer advantageously accommodates the consolidation of a range of items—by diversion to one or more chute(s) or other discharge assistant(s)—at corresponding bulk storage/shipment destinations such, for example, as one or more Gaylord-containers or pallet boxes.

Once an applicable container has been emptied or replaced, method 900 proceeds to 920. At 920, method 900 re-assigns destinations/containers to receive new groups of one or more items in fulfillment of the next order or sortation task in an applicable queue of tasks, and some or all of the preceding steps of method 900 are repeated until no further tasks remain in the sortation and/or item transport queue, at which point method 900 terminates or is suspended until additional item sortation and/or transport tasks are initiated.

Before proceeding with a continued discussion of embodiments of method 900 consistent with the present disclosure, it should be noted that the items transported by the carriers traversing the looped conveyance path may include a wide range of containers to be transported including cases, cartons, boxes too large to fit into a sort container serviced by a vertically movable platform, and bins. In the latter regard, the bins may be equipped with special surface features or attachments facilitating their extraction and replacement by a mobile retrieval vehicle, though such features are not essential because a variety of means are known in the art for extracting and manipulating any of the foregoing types of containers into which items have been deposited by sortation.

It should also be noted that systems and methods consistent with the present disclosure, are adapted to sort a far wider range of individual items to a far larger number of destinations over a desired time interval (be that interval a single eight-hour shift or a consecutive number of such shifts). By way of illustrative and non-limiting example, the diverse range of items which may be carried, discharged and transferred by embodiments consistent with the present disclosure (subject to giving due attention to any applicable item handling attributes when determining the destination of the items), includes paper goods (e.g., envelopes, greeting cards, magazines, books, maps, instruction manuals, pamphlets, brochures, business cards, and the like), articles of apparel (e.g., clothing and footwear), other wearable accessories (e.g., belts, scarves, hats, jewelry items, and eyeglasses and contacts), prescription and over-the-counter medications, pet toys and food products, electrical devices and parts, medical instruments, many components of entertainment systems, and a host of other items.

The association of groupings of items to individual sort locations may be performed on an ongoing basis (i.e., even after all available sort destinations have been associated with an item grouping). In such case, each sort destination may have a virtual queue of groupings associated therewith, such that an a priori association of multiple item groupings may be established for each sort destination. The groupings within a queue may have a default priority (e.g., a FIFO scheme) or in some embodiments, each grouping assigned to a sort destination queue may be assigned a priority class such that transfer of items belonging to a lower priority queue may be deferred until all of the higher priority groupings within the queue have been handled first. Moreover, the assignment of sort tasks to the arrays of containers is dynamically configurable in that a waiting, high priority grouping may be re-assigned to a different queue even where one or more item(s) is/are already present in the applicable container (provided, of course, that the items already present are common to the higher priority group as well).

By way of further alternate example, zones of sort destinations may be reserved for higher priority groupings, with groupings of items being assigned to sort destinations, on a round-robin basis as they become available. In any event, it suffices to say that a variety of methodologies-whether based on fairness or a premium delivery fee regime, may be employed to assign respective groupings of items to corresponding sort destination areas without departing from the spirit and scope of the present disclosure.

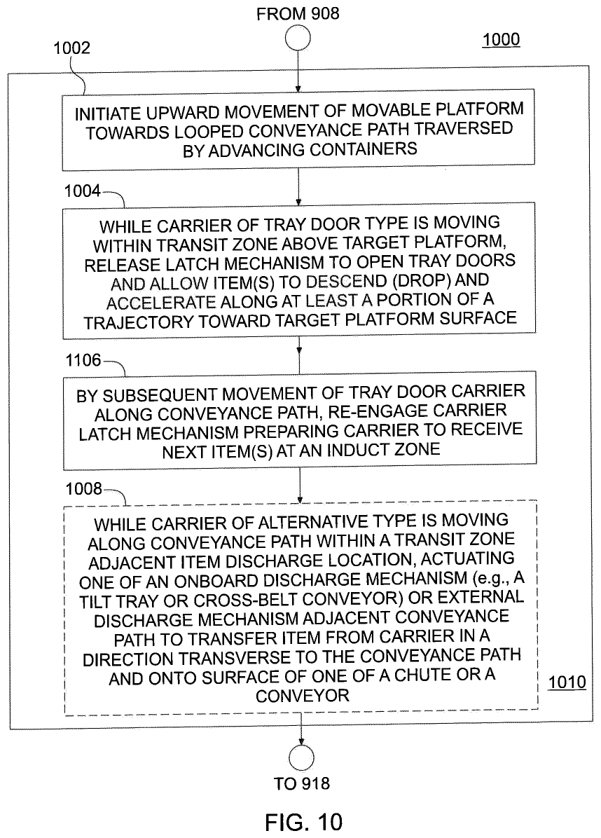

FIG. 10 is a flow diagram depicting discrete steps of a process 1000 applicable to the transport and discharge of items at locations along the looped conveyance path traveled by one or more carrier types according to one more embodiments of a method consistent with the present disclosure. In an embodiment, method 1000 is performed as a sub-process 1010 of method 900 (FIG. 9). As a sub-process, method 1000 proceeds from 908 of method 900 and implements 910, 912, 914 and, optionally, 916.

At 1002, method 1000 proceeds from 908 by initiating upward movement of a movable platform towards the elevated, looped conveyance path along which the carriers are continuously moved. At 1004, method 1000 discharges a first item from a carrier so that it descends along a first trajectory toward a first, upwardly facing target surface region of the movable platform below. Optionally, method 1000 discharges a second item from the same carrier so that it descends along a second trajectory toward a second, upwardly facing target surface region of the same or a different movable platform. In the former situation, method 1000 may operate the onboard transfer mechanism of the movable platform so that the first and second items are transferred to the same container (destination).

In the embodiment exemplified by FIG. 10, the carrier from which the first and/second item(s) is/are discharged by the method 1000 at 1004, is of a releasably latched, tray-door type wherein each of the first and second upwardly surface regions are respectively defined by coplanar surfaces of a corresponding pair of tray doors while such tray doors in a latched condition. Accordingly, at 1004, method 1000 releases a respective latch mechanism for one or both pairs of doors, as appropriate for the intended item destinations. The releasing of one or both of the latch mechanisms at 1004 is performed as the carrier is moving within a transit zone defined by the space directly above the target movable platform. In an exemplary embodiment, release of one or both of the latch mechanisms is performed by upwardly extending a corresponding pin actuator from the movable platform and bringing, by sufficient upward movement of the movable platform, the actuator(s) into engagement with one more linkages of the carrier dimensioned and arranged to unlatch the applicable release mechanism(s) holding the tray doors in coplanar relation. As a result of the unlatching operation performed at 1004, one or both pair(s) of tray doors open and allow items previously supported by the carrier to descend (drop) and accelerate along at least a portion of a trajectory toward a target surface of the platform. From 1004, method 1000 proceeds to 1006 by which subsequent movement of the carrier along the conveyance path causes engagement of a first inclined surface portion of each open tray door with a complementary inclined, stationary surface projection proximate the transit zone, thereby re-engaging the corresponding carrier door latch mechanisms and preparing such carrier to receive another item, or group of items, when the carrier again traverses an induction zone.

In embodiments, method 1000 optionally proceeds to 1008, wherein a carrier of an alternative type is moved by method 1000 along the looped conveyance path and enters a transit zone adjacent an item discharge location. At the discharge location, method 1000 actuates one of an onboard transfer mechanism as, for example, a tilt tray or cross belt conveyor, or an external discharge mechanism. In an embodiment, the discharge location is defined by a discharge assistant such as a chute, roller conveyor, or belt conveyor, such that actuation of the discharge mechanism causes transfer of an item from a carrier as its moves past the discharge location. Items transferred at the discharge location are moved in a direction transverse to the looped conveyance path. As used herein, the term “transverse” is intended by the inventors herein to encompass movement in any direction which diverges away from the direction of carrier movement at the point of transfer. As such, the direction of transfer may be orthogonal to the looped conveyance path, diverge at an acute angle relative to the direction of carrier movement, or diverge at an obtuse angle, according to the orientation and directional capabilities of the discharge mechanism employed. From 1008 (or 1006), method 1000 may, as a sub-process of method 900, return to method 900 at 918.

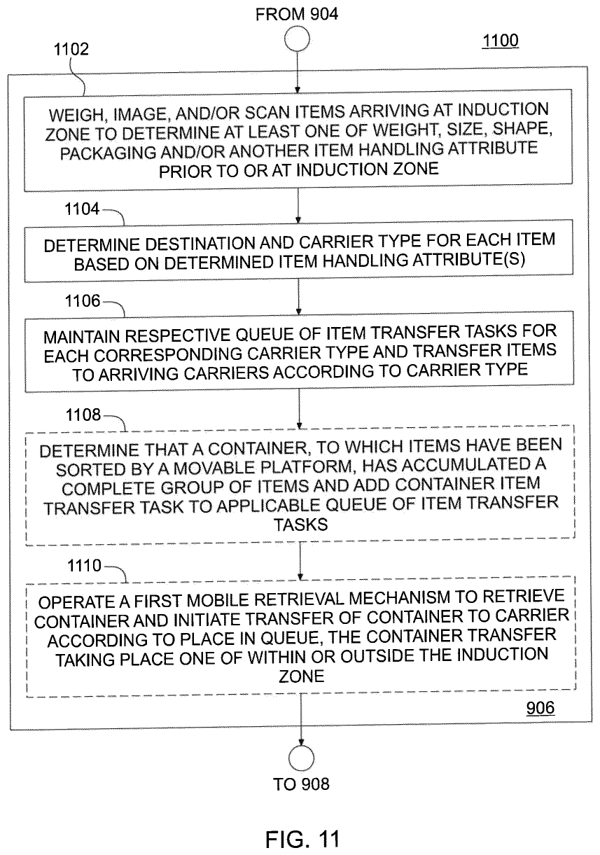

FIG. 11 is a flow diagram depicting discrete steps of a method 1100 which identifies or otherwise determines the item handling attributes and destinations arriving at an induct station of a plurality of such induct stations of an item induct zone, according to one more embodiments consistent with the present disclosure. In embodiments, method 1100 is performed as a sub-process of method 900 (FIG. 9) and is entered at 1102 as part of 906 of method 900. At 1102, one or more item handling attributes is/are acquired prior to their transfer to a carrier. Such acquisition may be performed by any conventional manner as, for example, by scanning an indicium (e.g., a UPC, EAN or ISBN code, a bar code, or GTIN), or interrogating an RFID tag) and using such information to acquire the item handling characteristics from a database, by utilizing sensors to determine item weight and/or dimensions, or any combination of these.

From 1102, method 1100 proceeds to 1104 where method 1100 determines a destination for each item, and the manner in which each item is to be transferred to the destination, based on one or more item handling attributes previously determined. Method 1100 proceeds from 1104 to 1106, where method 1100 updates a queue of item transfer tasks, by carrier type. That is, the transfer of items having a handling attribute rendering such items unsuited to transfer by dropping are assigned to a queue of transfer tasks which are implemented using transverse-discharging carriers, while the transfer of those items which are not restricted as to the manner in which they reach a destination are assigned to the carrier appropriate for the destination determined for those items at 1104. In some embodiments, items identified but for which a destination has yet to be identified may be allowed to transfer tasks of items for which no destination is identified may be placed in a divert area for exception handling, a subsequent re-scanning operation, or some other process.

It will be readily ascertained by the artisan of ordinary skill that a queue of item discharge tasks (not shown) may also be applied to control the timing and operating sequence of the corresponding discharge mechanisms and, if applicable, the movement profiles of the movable delivery platforms. Thus, for example, a discharge task associated with dropping a fragile item requires not only that dropping of the item occur at the proper time and location along the looped, carrier conveyance path, but also that such dropping is synchronized with downward acceleration and/or deceleration of the movable platforms so that the respective velocities of the descending item(s) and movable platform are appropriately matched to avoid damage.

A next queued item task is performed when the next available carrier of the carrier type needed for that task passes through the induction zone. In one or more embodiments, method 1100 may include projecting a light beam or other temporary fiducial marker onto a target surface to indicate to an operator where one or more items are to be placed on a passing carrier.

In one or more embodiments, method 1100 optionally manages the extraction, retrieval and transfer of containers into which a complete group of items have been transferred as, for example, in fulfillment of an e-commerce order to be fulfilled. Thus, at 1108, method 1100 determines that such a container has accumulated the last item needed to complete an order and adds a container extraction tasks to a queue of such tasks to be executed by, for example, a mobile retrieval vehicle movable into a position enabling extraction of that container and subsequent transfer to a carrier of the appropriate type. From 1108, method 1100 proceeds to 1110.

At 1110, method 1100 operates an extraction mechanism of a mobile retrieval vehicle (e.g., by extension to engage and retain a container and retraction to bring the container onto the retrieval vehicle) to retrieve the carrier identified during 1108 from its position among a vertically spaced group of containers. Method 1100 then initiates movement of the mobile retrieval vehicle to a transfer point and operates the retrieval mechanism of the mobile retrieval vehicle a second time (e.g., by extending the retained container, releasing it at the transfer point, and retracting it). The mobile retrieval vehicle is then free to perform the next task in the applicable task queue. In some embodiments, the transfer point is within an induction zone adjacent the looped conveyance path along which the carriers are moved, and the container(s) are transferred directly from a mobile retrieval vehicle onto a carrier of the appropriate carrier type. In other embodiments, the transfer point is at an elevator configured to move the extracted container vertically and transfer the container to a carrier of the appropriate carrier type. The transfer point need not be in or near the same induction zone as that in which induction of items is performed according to, for example, 1102 and 1104 described above.

### REFERENCE ELEMENTS

10 Automated Order Fulfillment (or Distribution) Center

20, 200 Warehouse Management System (WMS)

30 High Throughput, Item Transport and Sortation System\

40 Automated Storage and Retreival System

50 Order Entry and Scheduling System

60 RMA Processing System

110 System Controller

120 Bypass Carrier Actuator (e.g. Stage n Exception Handler)

130-1,2 . . . j, 400 Item Induct Stations or Modules

140 Carrier-Based Item Transfer System

150-1,2 . . . k Vertically Movable, Mobile Delivery Platforms

160-1,2 . . . m Item Group (Container) Retrieval Mechanisms

170 Tilt Tray/Diverter Actuator (e.g., Stage 1 Exception Handler)

202, 302, 402 Central Processing Unit(s)

204, 304, 404 Memory (e.g., RAM and/or ROM)

206, 306, 408 Input/Output (I/O) circuits

208, 308, 410 Support circuits

210, 309, 412 Network Interfaces

212, 312 Operating System

220 Sortation and Transfer Manager

230 Sort Destination Assigner Module

232 Item Group Queue Builder

234 Item Indicium (and/or Image) Database

236 Item Characteristic Database

238 Inducted Item Identifier

239 Group Priority Designator

240 Sortation Event Processor

242 Transfer Event Monitor

244 Completion Event Monitor

246 Jam Event Monitor

248 Exception Event Monitor

249 Destination Request/Specifier

241 Exception Event Processor

243 Exception Classifier

245 Stage 1 Exception Transfer Scheduler

247 Stage n Exception Transfer Scheduler

250 Container Transfer Module

254 Container Extraction Manager

256 Container Replenishment Manager

258 Container Destination Selector

260 Case Destination Module

262 Case Identifier

264 Case Destination Selector

270, 280 Other WMS Modules

320 WMS Interface Module

322, 439 Induct Event Reporter

324 Transfer Event Reporter

325 System Control Module

326 Jam Event Reporter

327 Exception Event Reporter

328 Destination Reservation Request Processor

329 Exception Handling Request Processor

330, 430 Induct Control Module

332,438 Induct Event Monitor

333,432 Feed Conveyor Control

334, 434 Image/Indicium Acquisition

335 Weight Characterization

336, 437 Outfeed/Transfer Control

338 Exception/Diverter Control

340 Item Delivery/Transfer Control

342 Platform Position

344 Door Actuator Operation

346 Discharge Mechanism Operation

348 Carrier Transfer Queue(s)

349 Transfer/Delivery Event Monitor and Confirmation

350 Container Retrieval and Transfer Control

352 Retrieval Vehicle Position Monitor

354 Container Transfer Manager

356 Retrieval/Transfer Event Monitor

358 Retrieval Vehicle Container Transfer Control

406 Local Controller

436 Weight Sensor(s) (for weight characterization)

442 First Feed Conveyor Stage

446 Second Feed Conveyor Stage

448 Transfer Conveyor Stage

470, 502 Carrier(s)

450, 450a-e Image Scanner(s)

452 Tunnel Frame w/Scanning Zone

460 Sensor(s)

470 Carrier

500 High speed and throughput sorting and transport system

504A, 504B Induction Zones

505 Column spaces

506A, 506B Rack structure

510 Sort destination (or target) containers

515, 517, 519 Mobile delivery platforms

521 Drive motor

530 Floor-elevation robotic induction zone

540 Elevated, automated transfer station

542 Inclined belt conveyor

602 Split-tray carrier

604a, 604b First set of split-tray carrier doors

606a, 606b Second set of split-tray carrier doors

612 Carrier of second type

700, 700a,700b Vertically movable, mobile delivery platform

702a, 702b platform actuator pin

704a, 704b latching mechanism actuator cam surface

706a, 706b latching mechanism actuator pin

708a, 708b latching mechanism bearing support

720 belt drive motor for displacing delivery platforms

722 drive belt for moving delivery platform

750a, 750b ramp

752 tray door follower surface

754a, 754b ramp surface

760 release mechanism spring

762 tray door release linkage mechanism

800 Extraction (and retrieval, transfer and insertion) vehicle

820 Extraction mechanism

As can be seen from the above, the system may be incorporated into a variety of systems that use physical guide mechanisms or guide the vehicles along open areas by directing the path to guide the vehicles to storage locations or transfer locations. As discussed above, the movement of each vehicle may be controlled in response to a determination of one or more physical characteristics of the item carried by each respective vehicle.

The embodiments of the present invention may be embodied as methods, apparatus, electronic devices, and/or computer program products. Accordingly, aspects of the present invention may be embodied in hardware and/or in software (including firmware, resident software, micro-code, and the like), which may be generally referred to herein as a “circuit” or “module”. Furthermore, embodiments of the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a list) of the computer-readable medium include the following: hard disks, optical storage devices, magnetic storage devices, an electrical connection having one or more wires, a portable computer diskette, a random-access memory (RAM), a read-only memory (ROM), an erasable programmable read-only memory (EPROM or Flash memory), an optical fiber, and a compact disc read-only memory (CD-ROM).

Computer program code for carrying out operations of embodiments of the present invention may be written in an object-oriented programming language, such as Java.RTM, Smalltalk or C++, and the like. However, the computer program code for carrying out operations of embodiments of the present invention may also be written in conventional procedural programming languages, such as the “C” programming language and/or any other lower-level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit embodiments of the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for transferring items to destinations, comprising:
advancing a plurality of carriers along an elevated and looped conveyance path, the conveyance path encompassing an item induction zone and overlying a plurality of movable platforms wherein each movable platform is configured to move vertically along a respective bidirectional path adjacent to a corresponding plurality of destination areas;
at the item induction zone, transferring items of the plurality of items to carriers of the plurality of advancing carriers without interrupting carrier movement;
determining that a first item is to be delivered to a destination of a first group of destinations accessible to a first movable platform;
dropping the first item, from a carrier of the plurality of advancing carriers, so that the first item descends along a trajectory toward a support surface of the first movable platform, wherein the first item descends at a first rate of acceleration.

2. The method of claim 1, further including, based on a determined characteristic of the first item, accelerating the movable platform downwardly from an initial position while the first item is descending along at least a first portion of the trajectory, acceleration of the movable platform being controlled to enable the first item to contact the first movable platform at a contact point disposed within a horizontal reference plane when a velocity of the first item and a velocity of the first movable platform are matched sufficiently to reduce a probability of impact damage to the first item.

3. The method of claim 2, further including controlling movement of the first item and first movable platform by at least one of continuing or initiating deceleration of the first movable platform in a direction downward and away from the horizontal reference plane;
positioning the first movable platform at a terminal location proximate the destination of the first group of destinations; and
operating a transfer mechanism of the first movable platform to transfer the first item to a container disposed at the destination of the first group of destinations.

4. The method of claim 2 or 3, wherein the accelerating includes accelerating the first movable platform at a second rate of acceleration, greater than the first rate of acceleration, until the velocity of the movable platform is substantially equal to the velocity of the first item.

5. The method of claim 3, wherein controlling movement of the first item and first movable platform includes decelerating the first movable platform until a velocity of the first movable platform is zero.

6. The method of claim 5, wherein the positioning includes moving the first movable platform vertically upwardly to the terminal location after the decelerating.

7. The method of claim 5, wherein the positioning includes moving the first movable platform vertically downwardly to the terminal location after the decelerating.

8. The method of claim 1, wherein the dropping comprises actuating a discharge mechanism of a carrier passing over the first movable platform.

9. The method of claim 8, wherein the actuating includes bringing a pin projecting upwardly from the first movable platform into engagement with a latch of the discharge mechanism to thereby allow a first pair of carrier elements to swing open downwardly and allow the first item to drop.

10. The method of claim 9, further including causing the open pair of carrier elements to swing upwardly and return to a latched engagement capable of supporting items.

11. The method of claim 1, further including based on a determined characteristic of a second item to be delivered to a destination of a second plurality of destinations accessible to a second mobile platform, maintaining the second movable platform in a stationary position until a dropped item contacts a support surface of the second movable platform.

12. A method for sorting and/or transporting items based on at least one varying item handling attribute, comprising:
advancing a plurality of carriers of multiple types along an elevated conveyance path,
wherein carriers of a first carrier type are respectively configured to transport and discharge items characterized by at least one item handling attribute of a first group of item handling attributes,
wherein carriers of a second carrier type are respectively configured to transport and discharge items characterized by at least one item handling attribute of a second group of item handling attributes,
wherein the conveyance path encompasses at least one induction zone, and
wherein at least a portion of the conveyance path overlies a plurality of item delivery platforms respectively movable vertically along one or more groups of item-receiving containers;
at the at least one induction zone, transferring items having an item handling attribute belonging to the first group to carriers of the first type;
transferring items having an item handling attribute belonging to the second group to carriers of the second type;
actuating one or more discharge mechanisms of carriers of the first type, at respective discharge locations above corresponding movable platforms, to drop one or more items onto each of the corresponding movable platforms; and
operating a transfer mechanism of the corresponding movable platforms, each from a position adjacent a container of the one or more groups of item-receiving containers, to accumulate an associated group of one or more items in the containers.

13. The method of claim 12, wherein items having an item handling attribute belonging to the second group are transferred to carriers of the second type at one or more locations outside of the induction zone.

14. The method of claim 13, further including operating a discharge mechanism of carriers of the second type to one of convey or offload items along paths transverse to the conveyance path and toward a corresponding destination.

15. The method of claim 12, further including operating an extraction mechanism of a retrieval vehicle to extract a container into which an associated group of one or more items has been accumulated and transport the extracted container toward a transfer zone for transfer of the extracted container to a carrier of the second type.

16. The method of claim 15, further including operating the retrieval vehicle to replace the extracted container with an empty container.

17. A material handling system for sorting a plurality of items into groups of one or more items, comprising:
a frame defining respective interior passages and corresponding entry openings dimensioned and arranged to allow items dropped, from above an entry opening, to enter into and descend within a corresponding interior passage;
at least one induct zone for supplying items to be conveyed and/or sorted to one or more groups of item-receiving containers arranged along the interior passages;
a plurality of movable platforms, each movable platform being dimensioned and arranged for vertical movement within an interior passage defined by the frame and defining a support surface dimensioned and arranged to receive and support one or more items of the plurality of items; and
a plurality of carriers configured for continuous movement along an elevated conveyance path,
wherein the plurality of carriers includes carriers of a first type respectively configured to transport and discharge items characterized by at least one item handling attribute of a first group of item handling attributes,
wherein the plurality of carriers includes carriers of a second type respectively configured to transfer and discharge items characterized by at least one item handling attribute of a second group of item handling attributes,
wherein the conveyance path of the carriers encompasses the at least one induction zone, and
wherein at least a portion of the conveyance path overlies the movable platforms, whereby items dropped from a carrier of the first type descend along a trajectory and onto one of the movable platforms.

18. The system of claim 17, wherein at least some carriers of the first type include one or more discharge mechanisms each actuatable, by an actuator of a corresponding movable platform of the plurality of movable platforms, to allow one or more items to drop onto the corresponding movable platform.

19. The system of claim 17, wherein at least some carriers of the second type include discharge mechanisms configured to convey or offload an item in a direction transverse to the elevated conveyance path.

20. The system of claim 19, wherein the discharge mechanisms of at least some carriers of the second type include at least one of a tilt-tray or a cross-belt conveyor for advancing items onto a chute or transfer conveyor.

21. The system of claim 17, further including a controller, wherein each movable platform is controlled by the controller to:
accelerate and decelerate at rates sufficient to enable a descending item to contact the movable platform, at a contact point disposed within a horizontal reference plane, when a velocity of the descending item and a velocity of the movable platform are sufficiently matched to achieve a reduced probability of impact damage in comparison to contact with a stationary movable platform at a point disposed within the horizontal reference plane,
decelerate, with the item disposed on the support surface thereof, until the item and movable platform are at rest, and
to advance to a terminal location proximate a target destination area.

22. The system of claim 21, wherein each movable platform includes
a motor operable, under control of the controller, to accelerate and decelerate said each movable platform, and
a transfer mechanism actuatable to transfer an item disposed on the support surface of the movable platform to the target destination area.

23. A material handling system for sorting a plurality of items into respective groups of one or more items, comprising:
a plurality of groups of destination areas, each respective group of destination areas being arranged in a corresponding column;
a controller;
a plurality of movable platforms, each movable platform having a transfer mechanism, defining an upwardly facing support surface, and being configured
to accelerate downwardly beneath a downwardly accelerating item, during a first phase of movement, at a rate greater than zero but low enough to allow the downwardly accelerating item to approach the support surface;
to decelerate downwardly, during a second phase of movement following the first phase, wherein the controller is configured to control at least one of acceleration or deceleration during the first and second phases of movement to allow the downwardly accelerating item to contact and be supported by the support surface; and
to stop, with a supported item, at a terminal position proximate a corresponding target destination area of a group of destination areas;
wherein the transfer mechanism of each movable platform is operable to transfer a supported item to the corresponding target destination area.

24. The material handling system of claim 23, further comprising an item carrier assembly, the item carrier assembly being configured
to receive items, of the plurality of items;
to transport the received items along a carrier travel path disposed within a plane overlying movable platforms of the plurality of movable platforms; and
to release received respective items at corresponding locations, the corresponding locations being arranged along the carrier travel path such that each released item descends along a trajectory that intercepts a descending movable platform of the plurality of movable platforms.

25. The material handling system of claim 22, wherein the carrier assembly includes a plurality of carriers, each carrier being configured to carry an item to be released while moving along the carrier travel path and to release the carried item at the corresponding location.

26. The material handling system of claim 23, wherein each carrier includes a release assembly comprising one or more doors movable between a support position enabling a carried item to traverse the carrier travel path and a release position allowing the carried item to drop away from the door(s) by gravity along a trajectory leading to a target movable platform.

27. The material handling system of claim 26, wherein the release assembly further includes a spring driven arm configured to open the door(s) and a sliding latch dimensioned and arranged to hold the door(s) in place until release by the release assembly.

28. The material handling system of claim 24, wherein each carrier further includes an actuator configured to initiate movement of the door(s) from the support position to the release position.

29. The material handling system of claim 26, wherein the doors are further configured with engagement surfaces engageable, by continued movement of the carrier, with ramp surfaces along the conveyance path to return the door(s) to the support position after release of a carried item.

30. The material handling system of claim 26, wherein each carrier further includes a carrier frame, wherein a first door is pivotably secured to the carrier frame by a first hinge for rotation about a first pivot axis, and wherein the release assembly further includes a second door pivotably secured to the carrier frame by a second hinge for rotation about a second pivot axis parallel to and spaced apart from the first pivot axis, whereby the first and second doors are respectively pivotable to release a carried item.

31. The material handling system of claim 27, wherein the release assembly of each carrier is a first release assembly, and wherein each carrier further includes a second release assembly having a third door pivotably secured to the carrier frame by a third hinge for rotation about a third pivot axis and a fourth door pivotably secured to the carrier frame by a fourth hinge for rotation about a fourth pivot axis parallel to and spaced apart from the third pivot axis, whereby the third and fourth doors are respectively pivotable to release a second item carried by said each carrier.

32. The material handling system of claim 27, wherein the release assembly is a first release assembly, and wherein each carrier further includes a second release mechanism having a door movable between a support position enabling a second item carried by the carrier to traverse a carrier conveyance path overlapping a portion of a carrier conveyance path traversed by the first item, and a release position allowing the second carried item to drop away along a trajectory and toward a movable platform.

33. The material handling system of claim 32, wherein each carrier further includes a first actuator configured to initiate movement of the door of the first release assembly from the support position to the release position, and a second actuator configured to initiate movement of the door of the second release assembly from the support position to the release position, whereby actuation of the door of the first release assembly allows a first item to drop away from a first carrier along a first trajectory and toward a first movable platform and actuation of the door of the second release assembly allows a second item to drop away from the first carrier along a second trajectory and toward a second movable platform.

34. The material handling system of claim 23, wherein the controller includes a processor and memory containing instructions, executable by the processor,
for controlling downward acceleration of each movable platform, of the plurality of movable platforms,
for controlling downward deceleration of each movable platform, of the plurality of movable platforms,
for stopping each movable platform, of the plurality of movable platforms,
for controlling motion of sorter trays of a second carrier type to allow for motion of the trays, and for coordinating timing of platform movements.

35. The material handling system of claim 34, wherein the processor is further configured to execute instructions, stored in the memory, for
resuming movement of a stopped movable platform to reach a terminal location proximate a target destination area of a group of destination areas, and
initiating operation of a transfer mechanism of the stopped movable platform to thereby transfer an item to the target destination area.

36. The material handling system of claim 32, wherein the instructions executable by the processor to advance a stopped movable platform include instructions executable to operate a motor of a first stopped movable platform to initiate vertical motion of the first movable platform in a first direction and to continue the vertical motion until the terminal location is reached.

37. The material handling system of claim 31, wherein the instructions stored in memory are executable by the processor for
determining that a first item has been released by a first carrier, and
responsive to the determining, controlling acceleration and/or deceleration of the first movable platform so that a velocity of the first item and a velocity of the first movable platform are, at an elevation where the released first item initially contacts the first movable platform, sufficiently close in magnitude to achieve a lower probability of damage to the first item as compared to damage which would result if the first item were to contact a stationary movable platform at the elevation.

38. The material handling system of claim 34, wherein responsive to the determining, acceleration of the first movable platform is controlled by the controller so that the first vehicle reaches the elevation at a point in time when the velocity of the first movable platform is substantially equal to the velocity of the first item.

39. The material handling system of claim 31, wherein the memory further contains instructions, executable by the processor, for
determining that the first carrier has reached a target location, of the locations sequentially arranged along the delivery path, associated with the first movable platform; and
operating, as the first carrier reaches the target location along the carrier travel path, the release assembly of the first carrier so that the first item descends along a first trajectory that intercepts the first movable platform at the elevation where the first item initially contacts the first movable platform.
